(19) United States
(12) Patent Application Publication
(10) Pub. No.: US 2026/0034739 A1
(43) Pub. Date: Feb. 5, 2026

(54) Control Architecture for Additive Manufacturing Robotic Systems

(71) Applicant: Relativity Space, Inc., Long Beach, CA (US)

(72) Inventors: Juraj Vanek, Long Beach, CA (US); Jonathan Bopp, Long Beach, CA (US); Jayasurya Sridharan, Long Beach, CA (US); Rocco DiVerdi, Concord, MA (US); Robert Jenkins, San Diego, CA (US); Jeremy Mika, Burbank, CA (US); Bryson Jones, Long Beach, CA (US); Saeed Hashemi, Los Angeles, CA (US); Lan Pham, Long Beach, CA (US); Anna Doris, Long Beach, CA (US); Brandon Ho, Long Beach, CA (US); Ishan Chadha, Long Beach, CA (US); Michael Wolf, Long Beach, CA (US); Kevin Smith, Monrovia, CA (US)

(73) Assignee: Relativity Space, Inc., Long Beach, CA (US)

(21) Appl. No.: 18/791,302

(22) Filed: Jul. 31, 2024

(51) Int. Cl. B29C 64/393; B29C 64/241; B33Y 50/02

(52) U.S. Cl. CPC B29C 64/393; B29C 64/241; B33Y 50/02

(57) ABSTRACT

Systems and methods for additive manufacturing robotic systems in accordance with embodiments of the invention are illustrated. One embodiment includes a method for visualizing a space. The method includes steps for receiving, at a set of one or more processors, a set of print data, wherein the set of print data comprises a first set of data for a first visualization, wherein the first set of data is received from a control system that controls a set of one or more robots for a print job to print a part, and a second set of data for a second visualization associated with the part, rendering, at the set of processors, the first and second visualizations based on the print data, wherein the first visualization includes a visualization of the print job, and displaying the rendered first and second visualizations.

### FIELD OF THE INVENTION

The present invention generally relates to software-implemented control systems. In particular embodiments, it relates to control architectures for additive manufacturing.

### BACKGROUND

Additive manufacturing is a process by which a product or part is manufactured by adding one layer of material on top of another in a sequence or pattern that would result in a solid part being built. This method of manufacturing is commonly referred to as three dimensional or 3D printing and can be done with different materials, including plastic and metal. Wire arc additive manufacturing is a production process used to 3D print and/or repair metal parts using a wire arc.

Additive manufacturing can be performed by one or more robots or gantry-style systems as common in CNC mills. Various robots and/or systems can be used to perform additive manufacturing and/or article processing steps.

### SUMMARY OF THE INVENTION

Systems and methods for additive manufacturing robotic systems in accordance with embodiments of the invention are illustrated. One embodiment includes a method for visualizing a space. The method includes steps for receiving, at a set of one or more processors, a set of print data, wherein the set of print data comprises a first set of data for a first visualization, wherein the first set of data is received from a control system that controls a set of one or more robots for a print job to print a part, and a second set of data for a second visualization associated with the part, rendering, at the set of processors, the first and second visualizations based on the print data, wherein the first visualization includes a visualization of the print job, and displaying the rendered first and second visualizations.

In a further embodiment, the first set of data further includes robot data for the set of robots and rendering the first visualization includes rendering representations of the set of robots.

In still another embodiment, the robot data includes at least one selected from the group consisting of arm length, arm angle, robot type, configuration data, robot connection, base width, and 3D model data.

In a still further embodiment, the first visualization and the second visualization differ in at least one selected from the group consisting of color and texture.

In yet another embodiment, the set of robots includes a plurality of robots, and displaying the rendered first and second visualizations includes displaying potential collisions between the plurality of robots.

In a yet further embodiment, the set of print data includes a print material for the part and rendering the first visualization includes rendering a texture based on the print material.

In another additional embodiment, the set of robots are simulated robots in a virtual space.

In a further additional embodiment, the set of robots are in a physical space, the second set of data includes sensed data from the physical space, and rendering the second visualization includes rendering a visualization of the print job based on the sensed data.

In another embodiment again, the sensed data includes data collected from a set of one or more sensors includes at least one selected from the group consisting of a camera, a laser scanner, a motion detector, and an accelerometer.

In a further embodiment again, the second set of data includes process monitoring data associated with a corresponding part, and rendering the second visualization includes rendering a visualization of a print job to print the corresponding part.

In still yet another embodiment, the second set of data is received from a database.

In a still yet further embodiment, the corresponding part is a historic print job of a prior printing of the part.

In still another additional embodiment, the process monitoring data includes at least one selected from the group consisting of TCP positions, axis position data, arc voltage data, temperature data, and weld parameters.

In a still further additional embodiment, rendering the visualization of the print job of the corresponding part includes generating a picking texture with object IDs associated each pixel of the picking texture, and the method further comprises receiving input identifying a pixel of the picking texture, and identifying a corresponding object based on the object ID associated with the identified pixel.

In still another embodiment again, displaying the rendered first and second visualizations includes displaying a delta between the rendered first visualization and the rendered second visualization.

In a still further embodiment again, the second set of data for the second visualization is based on a rendered visualization based on a third set of data received from the control system.

In yet another additional embodiment, the control system operates locally on the set of processors.

In a yet further additional embodiment, the control system includes a simulation module, wherein the first set of data includes simulated data, wherein the control system simulates a first portion, wherein rendering includes simulating a second portion.

One embodiment includes a method for updating a print plan. The method includes steps for receiving, at a set of one or more processors, a set of print data, wherein the set of print data includes robot path data from a control system that controls a set of robots, rendering, at the set of processors, visualizations based on the print data, identifying a set of issues based on the rendered visualizations, and communicating with the control system to update the print plan based on the identified set of issues.

In yet another embodiment again, the print data further comprises robot configuration data for a set of one or more robots in a print cell, and path data for the set of robots, and rendering visualizations based on the print data comprises rendering representations of the set of robots based on the robot configuration data, and rendering movement of the set of robots over time based on the path data.

In a yet further embodiment again, the print data further comprises a first set of print data of a print job being performed in a physical print cell, and a second set of print data of a target print job, and rendering visualizations based on the print data comprises rendering a first representation of the print job being performed in the physical print cell based on the first set of print data, and rendering a second representation of the target print job based on the second set of print data, wherein the target print job is computed using a physics engine.

In another additional embodiment again, the method further includes steps for rendering a visualization based on the updated print plan.

One embodiment includes a method comprising receiving, by a visualization environment, a robot configuration, receiving, by the visualization environment, a robot path, generating, by the visualization environment, a first visualization of a robot, based on the robot configuration, manufacturing a first part, based on the robot path, configuring the visualization environment to communicate with a control system configured as a local instance in a dummy mode or as a remote instance in a real mode, and further configured to stream telemetry to a database, transmitting, to the control system, the robot path, receiving, by the visualization environment, the telemetry from the control system, generating, by the visualization environment, a second visualization of a robot, based on the robot configuration, manufacturing a part, based on the telemetry, configuring the visualization environment to communicate with a database application, receiving, by the visualization environment, the telemetry from the database application, generating, by the visualization environment, a third visualization of a robot, based on the robot configuration, manufacturing a part, based on the telemetry.

One embodiment includes a method comprising receiving, by a monitoring application and from a first instance of a manufacturing application, telemetry data representing a session of a manufacturing robot implementing an additive technique, rendering, by the monitoring application and based on the telemetry data, a first graphical representation of at least a portion of the session through a first timestamp, wherein the first graphical representation depicts the manufacturing robot and a corresponding portion of a part manufactured through the first timestamp by the manufacturing robot using the additive technique, receiving, by the monitoring application, measurement data representing a physical location of the part, rendering, by the monitoring application and based on the measurement data, a second graphical representation of the physical location of the part, rendering, by the monitoring application and based on the telemetry data, a third graphical representation of at least the portion of the session through the first timestamp, wherein the third graphical representation depicts a physical property (e.g., print voltage) of the corresponding portion of the part, and displaying, by the monitoring application, the first graphical representation separately before displaying the second and third graphical representations contemporaneously.

In a further additional embodiment again, the monitoring application and the first instance of the manufacturing application are executing on the same computer.

In still yet another additional embodiment, the telemetry data includes axis position data and arc voltage data generated by the manufacturing robot.

In a further embodiment, the measurement data includes a point cloud generated by a laser distance sensor.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as embodiments of the invention and should not be construed as a complete recitation of the scope of the invention.

FIG. 1 illustrates an example of a robotic additive manufacturing cell in accordance with an embodiment of the invention.

FIG. 2 illustrates an example control system in accordance with an embodiment of the invention.

FIG. 3 illustrates an example planning and control node in accordance with an embodiment of the invention.

FIG. 4 illustrates an example of a plugin host for controlling robotic systems in accordance with an embodiment of the invention.

FIG. 5 illustrates an example of a visualization environment in accordance with an embodiment of the invention.

FIG. 6 illustrates an example of a visualization UI that illustrates a visualization of multiple print spaces in accordance with an embodiment of the invention.

FIG. 7 illustrates an example of a visualization UI that illustrates visualizations of a print cell in accordance with an embodiment of the invention.

FIG. 8 illustrates an example of a visualization UI that illustrates a printed part visualization in accordance with an embodiment of the invention.

FIG. 9 illustrates an example of a visualization UI that illustrates a point data interface in accordance with an embodiment of the invention.

FIG. 10 illustrates an example of a visualization UI that illustrates layer heights of a print job shown in a render in accordance with an embodiment of the invention.

FIG. 11 illustrates an example of a visualization UI that illustrates process monitoring data for sections of a printed part in accordance with an embodiment of the invention.

FIG. 12 illustrates an example of playback of a print job in accordance with an embodiment of the invention.

FIG. 13 illustrates an example of a simplified UI for playback of a print job.

FIG. 14 illustrates an example of a visualization UI that illustrates a render of different aspects of a printed part in accordance with an embodiment of the invention.

FIG. 15 conceptually illustrates an example of a process for dynamic control in accordance with an embodiment of the invention.

FIG. 16 conceptually illustrates an example of a process for multiple visualizations in accordance with an embodiment of the invention.

FIG. 17 conceptually illustrates an example of a process for visualizing a manufacturing process in accordance with an embodiment of the invention.

### DETAILED DESCRIPTION

Systems and methods in accordance with a variety of embodiments of the invention control multiple robots (or other robotic elements, such as welders, tables, monitoring systems, etc.) across one or more workspaces (or cells). In some embodiments, systems can provide controllers (or plugin hosts) that provide real-time instructions to the robots based on non-real-time instructions. Systems in accordance with several embodiments of the invention can provide various real-time and/or non-real time processes with shared access to control one or more robots. In a variety of embodiments, systems coordinate access by multiple robots to a shared physical space (e.g., coordinating motion between a 6-axis robotic arm and a 2-axis rotating positioner with a tilting trunnion axis).

In some embodiments, systems provide an internal abstraction layer for low level interfacing with and coordinating of 3rd party hardware. Systems in accordance with some embodiments of the invention provide a platform that robustly handles the large and high-speed nature of the data used for robotics generally, as well as flight vehicles, and propulsion testing. In some embodiments, systems can provide controls for distributed action planning and/or actuation.

Systems and methods in accordance with a variety of embodiments of the invention can provide high levels of coordination between components of a system where the system may not be static. For example, processes in accordance with some embodiments of the invention can enable changes (e.g., wire feed speeds, robot motion speeds and/or directions, path parameters, weld parameters, etc.) to various components (potentially from various disparate vendors) within a system, where changes in one component of the system can drive changes in another component. In a number of embodiments, changes can alter the future planning of all subsystems within a system beyond making corrective adjustments to pre-planned motions.

In some systems, such coordination can be difficult. Different robots may take instructions at different rates and via different protocols. For example, a robot manufactured by KUKA AG (Augsburg, Germany) may take commands every four milliseconds (at 250 Hertz), a weld system may be much slower, and a weave axis may be much faster, utilizing a motor drive running at 8000 Hertz. The difficulty in coordinating operations becomes even more complex when the system is not static. For example, changing wire feed speed in coordination with the robot path can be difficult, because the wire feed speed and the robot path are controlled by different motors made by different vendors that do not natively communicate with each other. Further difficulty arises if each print cell does not use the same models of components configured in exactly the same way. There are multiple sources of latency: communication latency (in which the method of communication to a subsystem takes an amount of time specific and unique to that subsystem), cyclic latency (in which the computation cycle of a system is early/late respective to other systems), and hysteresis in which the system needs to overcome some physical constraint like inertia, gravity or stiction (for example).

With the system structure described in this specification, systems and methods in accordance with various embodiments of the invention may run out a preplanned buffer of those commands, allowing for coordinated movement of equipment regardless of their control systems, manufacturers, models, native operating system, command frequency, etc. In a variety of embodiments, processes may schedule commands into a timeline to synchronize various components in a system. Processes in accordance with numerous embodiments of the invention may define constraints (e.g., based on physics, hardware limits, etc.). Constraints in accordance with numerous embodiments of the invention may be used to limit and/or define timelines (or schedules) for various elements in a system. In several embodiments, scheduling may include time shifting certain operations based on constraints.

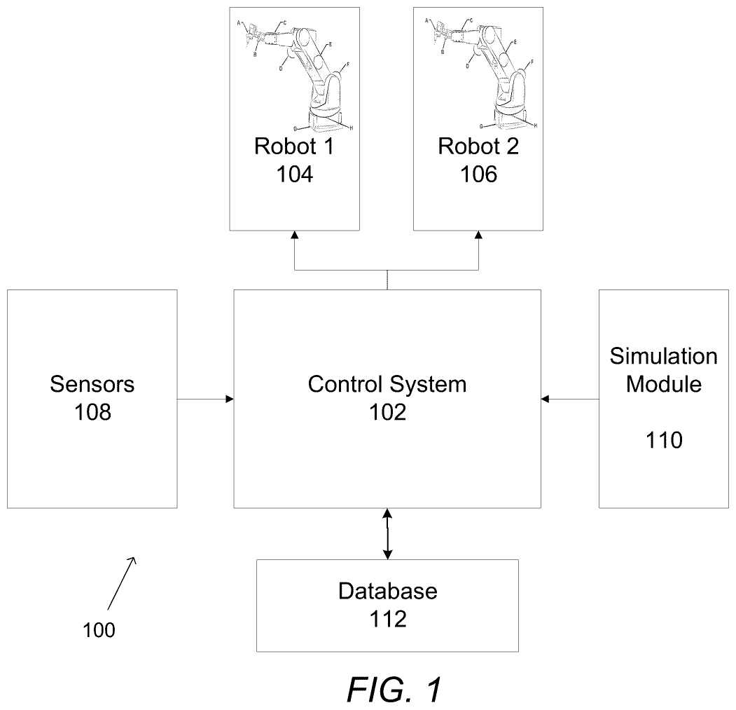

Turning now to the figures, an example of a robotic additive manufacturing cell is conceptually illustrated in FIG. 1. In this example, robotic additive manufacturing cell 100 includes control system 102, robots 104 and 106, sensors 108, simulation module 110, and database 112. In this example, control system 102 controls a first robot 104 and a second robot 106. In a number of embodiments, controlling robots can include sharing resources and/or scheduling the operations of different robots in a system. Robots in accordance with some embodiments of the invention can be capable of additively manufacturing an article. In various embodiments, robots include (but are not limited to) robots manufactured by ABB Ltd. (Zurich, Switzerland), a KUKA robot, etc.

Control systems in accordance with certain embodiments of the invention can include one or more nodes for control, including planning and control nodes, plugin hosts, etc., examples of which are described throughout this specification. Control system 102 receives data from one or more sensors 108 and simulation module 110. The control system 102 can also control the robots 104 and 106 based on received data.

Sensors (or perception nodes) can provide various types of data regarding a system, such as location, motion, alignment, pose, state, etc. Sensors in accordance with a variety of embodiments of the invention can be mounted to robots and/or other system components. In many embodiments, sensors can be any of a variety of sensors including cameras, motion detectors, accelerometers, laser scanners, etc.

Simulation modules in accordance with a number of embodiments of the invention can be a computer system that performs any of a number of different simulations, including live model slicing, part simulations, weld simulations, cell simulations, and/or other simulations. In some embodiments, simulations from simulation models can be used to generate action plans to coordinate one or more robots in performing a task, and/or to perform a corrective procedure or action that will result in meeting the tolerances specified in the input to the system. In many embodiments, simulation modules are a part of a visualization environment, such as visualization environment 500, designed to display various visualizations.

Simulation modules in accordance with a variety of embodiments of the invention are a part of control systems used to plan and/or control manufacturing systems. In various embodiments, simulations may be performed both within control systems and within separate visualization environments. For example, simulations in accordance with various embodiments of the invention may be performed so that a first part is performed as part of a control system while a second part is performed as part of a visualization environment. Alternatively, or conjunctively, simulations in accordance with various embodiments of the invention can be divided between control systems and visualization environments, based on various factors, such as (but not limited to) load balancing, visualization type, user settings, etc. In a number of embodiments, visualization environments communicate with control systems that operate as local and/or remote instances.

Databases in accordance with certain embodiments of the invention can communicate with control systems to provide and/or store information related to print jobs, including (but not limited to) historic print data, robot data, print cell data, etc. In a number of embodiments, databases may be shared between various components (e.g., control systems, visualization environments, etc.).

In several embodiments, control systems can provide advantages for the implementation of robotic additive manufacturing systems. Systems and methods in accordance with certain embodiments of the invention can facilitate sensor integration, streamlined simulated data, hardware in the loop (HIL) testing and/or data capture. In many embodiments, systems can enable:
quick prototyping of visualizations and/or instrumentation;
quick validation of cell layouts and configurations and/or reach studies;
greater capability and control over deposition system (e.g., weld) parameters and/or robot motion;
offline simulation and/or visualizations of print jobs (e.g., prior to or after a print job);
online visualizations of what the system is doing during a print job; and/or.
intuitive 3D interfaces to making adjustments to the system with confidence that the system will react in the way the user expects.

Systems in accordance with a number of embodiments of the invention allow for dynamic print control (e.g., adding and/or removing robots from manufacturing cells, servicing the wire feed stock, etc.) without stopping the print job. Legacy systems may have required a controller to send robot control points at least 30 seconds in advance or may have required welder control to be tied to path points. In some cases, they can have details of synchronization between welder, robot, and external sensors obfuscated by subsystem implementations or may have required calibration to be performed through the robot. They may also have limited robot and welder control and/or may have required convoluted I/O mapping and some upside-down design patterns. A CNC controller could treat two 6-axis robot arms as a single 12-axis machine, and while this would suffice for pre-planned motions for both robots, the robots and their sensors would be limited to the pre-planned motion and not able to react as independent heterogenous agents.

Systems in accordance with certain embodiments of the invention can provide a user with an improved understanding of the current state of various systems. In certain embodiments, clear pathways for closed loop control of robot, welder, and/or other system components can be provided, requiring less complexity in hardware specific code (e.g., KRL code) on robots. Systems in accordance with many embodiments of the invention can provide improved data logging speeds (e.g., 1000 Hz and up) as well as live-tuning of path parameters and/or weld parameters during a print job. In several embodiments, systems may enable a print process to be paused and/or unpaused, operate cells with multiple robots, and/or run control processes on a variety of platforms (e.g., on a laptop, Raspberry Pi, and MacOS for development, and on QNX, VxWorks, and Green Hills Integrity for production).

### Control Systems

Control systems in accordance with some embodiments of the invention can control robots (or other robotic elements, such as welders, tables, monitoring systems, etc.) across one or more workspaces (or cells). In certain embodiments, control systems can perform processes across one or more computer systems (e.g., server clusters, single and/or multi-processor computers, integrated circuits, etc.) that may communicate across various channels, such as cloud systems, local area networks, wide area networks, the Internet, etc. Processors in accordance with a number of embodiments of the invention perform instructions stored in memory to manipulate data stored in the memory. Processor instructions can configure processors to perform processes in accordance with certain embodiments of the invention. In various embodiments, processor instructions can be stored on a non-transitory machine readable medium.

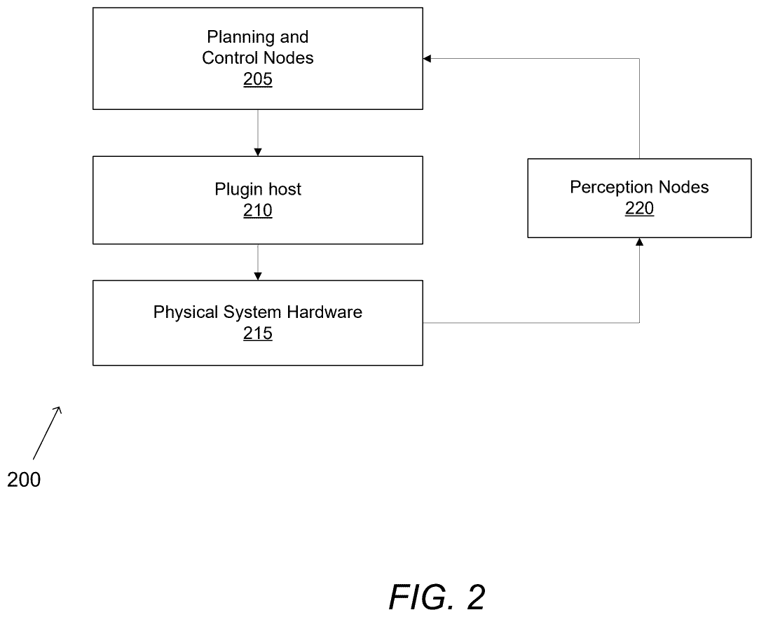

An example control system is conceptually illustrated in FIG. 2. Control system 200 includes planning and control nodes 205, plugin host 210, physical system hardware 215, and perception nodes 220. In this example, planning and control nodes 205 communicate with plugin host 210 to control physical hardware 215 based on sensed data from perception nodes 220.

Planning and control nodes (or modules) in accordance with a number of embodiments of the invention can provide high level controls, plans for physical hardware systems, and/or visualizations of various print jobs (e.g., planned, actual, offline, online, etc.) and/or printed parts. In certain embodiments, planning and control nodes can provide non-real-time controls (or plans) to plugin hosts, which can translate the non-real-time plans to real-time plans for controlling physical hardware. In a number of embodiments, planning and control nodes can include interfaces for manual controls and/or automated controls. Planning and control nodes in accordance with many embodiments of the invention can provide dynamic controls for components of a physical hardware system in response to sensed data and/or robot state data in a physical hardware system. In a variety of embodiments, planning and control nodes can interact with visualization environments to generate visualizations, review and update print plans, etc.

Planning and control nodes in accordance with some embodiments of the invention can be based on outputs from various inputs, including state estimation processes, sensed data, visualization environments, etc. In many embodiments, state estimation processes can identify state estimates of various parts of the system (e.g., robots, cells, welders, etc.) as well as the in-process part that is being manufactured. State estimation processes in accordance with certain embodiments of the invention may be based on sensed data and/or other data from the system. In a variety of embodiments, sensed data (e.g., location, motion, pose, state, etc.) can be received from perception nodes and/or directly from physical system hardware.

Plugin hosts in accordance with some embodiments of the invention can be configured to control and coordinate physical hardware systems, which may include various components of various types. In a number of embodiments, plugin hosts can share resources and coordinate activities between different elements of a physical hardware system.

In several embodiments, physical system hardware can include robots, positioner tables, lifts, and/or deposition systems (e.g., additive manufacturing deposition systems, powder bed systems, and/or torches suitable for wire arc additive manufacturing (WAAM)). Physical system hardware can interact and/or navigate within an environment, on a part (e.g., an article), and/or within a cell (e.g., an additive manufacturing cell).

Perception nodes in accordance with various embodiments of the invention can receive sensed data (e.g., position, location, motion, state, pose, etc.) related to physical system hardware and/or to the environment of operation, article of manufacture, and/or manufacturing cell. In various embodiments, perception nodes can include motion capture systems, cameras, laser scanners, and/or inertial measurement units. In numerous embodiments, sensors can be registered to the system such that it is associated with one or more robots, deposition systems, tables, environments, articles, and/or cells. In various embodiments, sensed data generated by sensors can be provided to a state estimation process. State estimation processes in accordance with numerous embodiments of the invention can be used to determine states (e.g., location, motion, alignment, pose, etc.) for one or more robots, deposition systems, tables, environments, articles and/or cells. State estimation in accordance with certain embodiments of the invention is described in greater detail herein.

While specific examples of control systems are described above, any of a variety of control systems can be utilized as appropriate to the requirements of specific applications. In certain embodiments, various functionalities may be distributed across multiple elements or consolidated into a single element. In some embodiments, one or more of the elements of a control system may be omitted or additional elements may be included. Although many embodiments of the invention are described in reference to additive manufacturing systems, the techniques disclosed herein may be used in any type of robotics application.

### 1. Planning and Control Nodes

Planning and control nodes in accordance with many embodiments of the invention can include various elements for planning and control. In several embodiments, planning and control nodes can allow for dynamic control of a physical hardware system. Dynamic control can include modifying operating parameters for one or more robots, welders, and/or tables in a cell, adding/removing robots from a cell, etc. In many embodiments, planning and control nodes can provide for centralized error reporting and/or detection, direct control of component parameters, dynamic positioning controls (e.g., for collision avoidance), and/or visualizations (e.g., of print cells, print jobs, robots, print paths, printed parts, live print jobs, archived print jobs, simulated print jobs, etc.).

Planning and control nodes in accordance with a variety of embodiments of the invention can generate and/or update plans based on various inputs, such as detected errors, sensed data, simulation data, visualization data, updated instructions, etc. In some embodiments, planning and control nodes can use centralized error detection to allow for a system to identify errors (or faults) within the system. Centralized error detection in accordance with some embodiments of the invention allows a system to gather messages from various components (e.g., sensors, robots, welders, visualization environments, etc.) of a system to detect and/or report errors in the system. In numerous embodiments, centralized error detection can include aggregating errors from different components, detecting errors based on messages from different components, etc. Error detection in accordance with several embodiments of the invention can include predicting future errors (e.g., collisions, print errors, etc.). Centralized error detection in accordance with some embodiments of the invention is described in further detail below.

In a number of embodiments, planning and control nodes can include visualization environments that generate visualizations of a desired print job, a live print job, etc., which can be used to modify plans before and/or during a print job. Visualizations in accordance with some embodiments of the invention can be used to display and/or detect errors, whether before, during, or after a print job.

In several embodiments, planning and control nodes provide direct control of component parameters. In many existing systems, component parameters are communicated as discrete parameter sets that are switched, preventing a system from dynamically adjusting to different situations in a timely manner. Planning and control nodes in accordance with various embodiments of the invention can drive component parameters (e.g., gas flow, weld current, voltage, wire feed speed, etc.) directly. In certain embodiments, planning and control nodes can derive component parameters based on other parts of a job plan (e.g., parameters for other components in the system). For example, processes in accordance with a number of embodiments of the invention determine welding inputs (e.g., weld current and/or wire feed speed) based on motion parameters (e.g., speed and/or direction) for the robot moving the welder along a path. Direct control of component parameters in accordance with some embodiments of the invention is described in further detail below.

Planning and control nodes in accordance with various embodiments of the invention provide dynamic positioning controls for a system. Dynamic positioning controls in accordance with various embodiments of the invention can continuously monitor a state of a space (e.g., a cell) to determine the appropriate positioning of components within the cell. In some embodiments, dynamic positioning controls can be used to perform collision avoidance. In numerous embodiments, planning and control nodes can aggregate and/or determine positions of components in a system, and/or predict a future position or path of various components (e.g., robots, robotic arms, welders, etc.) in order to position each component to avoid collisions and/or improve performance. In various embodiments, planning and control nodes can generate and/or maintain an occupancy grid to determine whether a point in 3d space is occupied. Occupancy grids in accordance with certain embodiments of the invention can be stored in various data structures, such as a 3D grid of elements that indicate (e.g., with a number) whether the location is occupied. Dynamic positioning controls in accordance with numerous embodiments of the invention are described in greater detail below.

Planning and control nodes in accordance with numerous embodiments of the invention can provide fault tolerant processes. Fault tolerant processes can include those processes where a print job can proceed even after a detected error (e.g., failure) of at least one robot in a robotic additive manufacturing cell. In some embodiments, a process can include receiving an indication that a health state condition has been met (e.g., a fault, an excess of buildup on a part), and based on that condition and/or sensor data (e.g., sensor data indicative of robot status, sensor data indicative of article status) can generate new toolpaths for one or more robots remaining in the robotic additive manufacturing cell. The robot with the fault can be removed for repair. Planning and control nodes in accordance with some embodiments of the invention can enable this capability without requiring the manufacture of the article to be stopped in accordance with embodiments of the invention.

For example, in many embodiments, dynamic weld controllers can control one or more parameters of welding processes. This can beneficially allow dynamic adjustments to wire feed speed, current, and/or pulse patterns. Dynamic adjustments can be based on what is happening with the print job (e.g., based on the toolpath, the sensor output, the article state, outputs from state estimators, rate-of-turn, density of geometry, waviness, sensing, and/or other considerations).

In accordance with many embodiments of the invention, planning and control nodes can utilize visualization, simulation and/or validation of various processes and/or hardware to determine plans (e.g., corrections and/or trajectories) for the elements of a hardware system.

Planning and control nodes in accordance with many embodiments of the invention may include Robot Operating System (ROS) nodes. In numerous embodiments, ROS nodes can provide various functionality for controlling a robot. In numerous embodiments, ROS nodes are non-real-time nodes that provide non-real-time instructions to plugin hosts, which can manage the real-time operations of the system.

In certain embodiments, planning and control nodes manage communications for a system. Communication management processes in accordance with numerous embodiments of the invention can manage communications between different nodes/processes, visualization environments, and/or databases. In numerous embodiments, communication management processes can manage communications between ROS nodes and other parts of a control system (e.g., plugin hosts). ROS nodes in accordance with several embodiments of the invention can use communication management processes to provide various functions (e.g., user interfaces, visualizations, databases, etc.) to a control system.

In several embodiments, ROS nodes communicate plans (e.g., from user interfaces, planning and control nodes, etc.) with plugin hosts via communication protocols (e.g., Data Distribution Service (DDS)). In many embodiments, communication management processes can include a subscriber (e.g., an ROS subscriber) and/or a publisher (e.g., an ROS publisher). In some embodiments, communication processes and plugin hosts can operate on different computer systems. Although many of the examples described herein describe different processes (e.g., communication management) as part of a specific component, one skilled in the art will recognize that similar systems and methods may alternatively, or conjunctively, provide such processes at other elements (e.g., at plugin hosts), without departing from this invention.

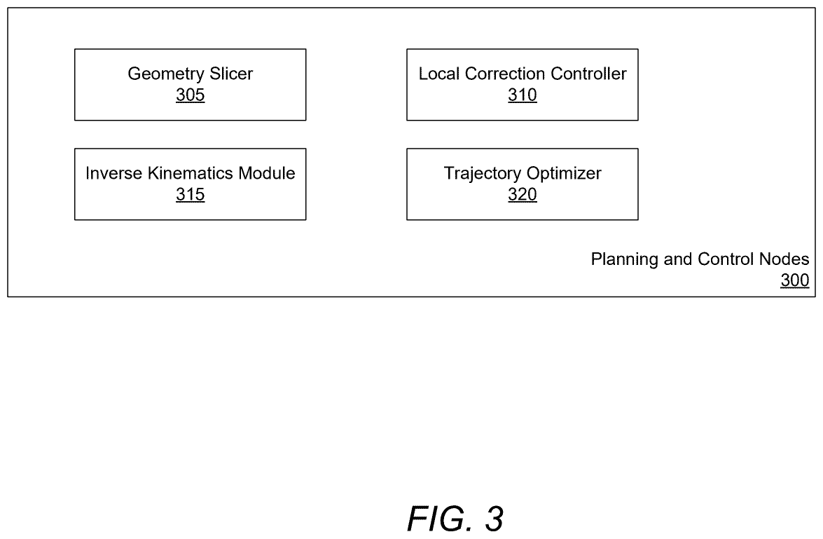

An example of a planning and control node in accordance with an embodiment of the invention is illustrated in FIG. 3. Planning and control node 300 includes geometry slicer 305, local correction controller 310, inverse kinematics module 315, and trajectory optimizer 320.

Geometry slicers in accordance with a number of embodiments of the invention can determine desired geometries of material to be added to articles. Local correction controllers in accordance with several embodiments of the invention can evaluate the current (or projected) state of a desired geometry and determine local corrections based on target geometries from a geometry slicer.

Inverse kinematics modules in accordance with several embodiments of the invention can compute inverse kinematics to determine the movements or motions for a robot to reach a target position or pose. Trajectory optimization modules in accordance with several embodiments of the invention can determine a desired trajectory that optimizes some set of one or more objectives while satisfying a set of one or more constraints based on computed inverse kinematics.

While specific examples of planning and control nodes are described above, any of a variety of planning and control nodes can be utilized as appropriate to the requirements of specific applications.

a. Centralized Error Reporting

Systems and methods in accordance with many embodiments of the invention utilize centralized error reporting (and/or detection) to identify errors in a system that may contain many diverse components (or subsystems).

The inventors realized that, when troubleshooting an additive manufacturing system that is relying on multiple subsystems (such as a robot, a welder, a wire feeder, sensors, and so forth), each system has its own interface and its own error reporting. They recognized that it can be difficult, whenever an overall system (e.g., a print cell) stops working or isn't working, to find out why it stopped. Each individual component may provide different types of messages and it can be difficult to decipher or identify a root cause for a problem. In some cases, a problem in the system may not be the result of an error within any individual component, but rather a systemic issue that is not arising from any one component, and there may not be an error message from which to begin troubleshooting. Examples of systemic errors can arise from an EtherCAT motion controller node, a weld parameter node, a weave node, a collision avoidance node, a cell control node, a part state estimator, or a combination thereof.

In prior systems, a welder would be controlled by the robot within a print cell. The weld system's error information would only be available through that robot system. That may be adequate for robotic welders that are performing ordinary welding operation, because robot manufacturers, from their rich history in automotive plants, have a good understanding of what errors need to be surfaced to the user. But such a system is inadequate for additive manufacturing, which encounters different errors than welding. Robot manufacturers lack understanding of tool-specific and systemic error conditions that can and should be surfaced.

Systems and methods in accordance with a variety of embodiments of the invention provide a single interface for error reporting for plural and, in some embodiments, all components (or subsystems) of a system. In numerous embodiments, components may provide native error codes generated by the individual component. Processes in accordance with certain embodiments of the invention may receive error reports for a given component from channels external to the component. For example, processes in accordance with numerous embodiments of the invention may detect errors (e.g., safety system faults, wire feed errors, missing robots, etc.) for a component based on sensed data, error messages, and/or data messages (e.g., system logs) from other components in the system. For example, if wire feed speed is lagging the set point, an error may be detected when no other machine may be flagging an error in that situation, e.g., based on the current wire feed speed and/or instructions issued to the weld system. Conditional alarms may be based on data from multiple systems. As another example, in the case of a safety system fault, errors may be reported to indicate which part of the system to look at. The safety system may be a loop including the robot, a programmable logic controller (PLC), and/or all the stops and door sensors. Data from elements of the loop can be used to make a determination of what subsystem to point to.

In numerous embodiments, error reports can be received from visualization environments. Visualization environments in accordance with a number of embodiments of the invention can detect potential defects, collisions, and/or other errors based on simulations, sensed data, prior print data, etc. In some embodiments, systems and processes may check whether a system is ready to perform a given task. For example, in a print process, processes in accordance with several embodiments of the invention can check whether the welder and/or robot are in a ready condition, as well as whether the safety conditions have been met. If these conditions are not met, then the system may prevent the system from initiating a print job. That contribution is significant. For example, in a prior additive manufacturing print cell, there is no mechanism for the welder to report to a user that the welder cannot find the robot, because the welder is unaware that there is a robot it should connect to. Because the embodiments described above have exposure to the entire communication chain, the system can detect when a machine is not present and generate a responsive alarm. Again, a welder cannot generate that error itself.

In some embodiments, when conditions are not met, various actions may be triggered, such as an alarm, notifications, system checks, data collection, etc. to investigate the root cause. For example, turning to a higher level above merely the welder node, for a system level alarm, the system can detect that a user has loaded a print path and wants to commence a print job. The system can check whether the welder is ready, whether the robot is ready, and whether safety is ready. If the system does not see all three conditions, then it knows that the cell is not ready to print. It could produce an alarm or investigate the root cause why. For example, the system could detect a high network latency and warn the user that there is a network condition that could affect a print job and suggest waiting until the network condition resolves. The system therefore gives users more intelligence than anything previously possible which is based on reported conditions alone. Again, some errors can be reported up from a single machine (such as reported up from the welder node). Or it can report information from the print controller, which has perspective into the robot, the welder, and the safety system. More expansive combinations of nodes and error reporting are available with the foregoing system.

b. Direct Control of Component Parameters

Previously, an additive manufacturing process would make use of multiple parameter sets over the course of a print job, operating for a time with one qualified parameter set and then, after an operator instruction following a change in process conditions, switching to different qualified parameter set. Systems and methods in accordance with certain embodiments of the invention provide individual driven parameters (such as weld parameters), or subsets of driven parameters, rather than entire parameter sets that are switched. Processes in accordance with numerous embodiments of the invention can use driven parameters (individual, sets, subsets, or combinations thereof) during various processes described throughout this specification, including (but not limited to) actual print jobs and/or simulated print jobs.

Driven parameters in accordance with a variety of embodiments of the invention can include gas flow, weld current, voltage, wire feed speed, slope in, slope out, etc., individually or as subsets. Using driven parameters that can directly indicate a specific instruction for each variable or subset of variables (rather than a fixed group or entire set of parameters), provides increased fidelity and accuracy in a job as the control of each parameter is explicit. In numerous embodiments, driven parameters allow for greater optimization of a job, because rather than searching for the best parameter set that pass tolerance, each individual parameter can be optimized and adjusted during a job.

In some embodiments, driven parameters can be model-driven. Processes in accordance with many embodiments of the invention can drive the values of the parameters (e.g., voltage, current, wire feed speed, etc.) dynamically, changing them during a job, based on inputs about the state of each component (or part). In a number of embodiments, parameters may be driven based on predictive models that modify parameters based on inputs (e.g., component state, part state, sensed data, etc.) from the system. For example, given a robot speed, a process could create a coefficient for current and wire feed speed and thereon determine the weld outputs. E.g., using a given robot speed, a coefficient of (e.g.) 0.7 times the wire feed speed, and a coefficient of (e.g.) 0.3 times the amperage, the process can determine the weld outputs.

In a variety of embodiments, systems can drive parameters of various components using multiple different protocols and/or channels. As different components may expose different parameters using different protocols, systems in accordance with many embodiments of the invention can use multiple different protocols (or channels) to update different parameters for a particular component. In a number of embodiments, processes may utilize plugins to communicate using different protocols and/or channels. Plugins in accordance with various embodiments of the invention are described in greater detail below.

c. Dynamic Positioning Controls

With additive manufacturing, it can often be necessary to close off a safe working area as a print job progresses. As more components are added to a workspace, it becomes increasingly important to avoid collisions, which may cause costly damage and/or delays. When the print job begins, there may be a large safe working area, but as the print job progresses and deposits material in the previously empty working area, there may be a part that obstructs the desired path.

Systems and methods in accordance with some embodiments of the invention can perform collision avoidance by providing centralized planning and control nodes that receive information about the status of a project. For example, in a print cell, processes in accordance with numerous embodiments of the invention can estimate the state of a part to identify the portions of the cell that are occupied. In this example, if a technician is doing a maintenance task where they're moving the robot manually around, processes tracking the state of the cell can identify the moved robot and identify potential collisions with previously initiated print processes.

Many existing components do not have any information about what is in the surrounding environment (e.g., within a print cell). Existing systems have tried to solve this problem with Lidar sensors or area scanners, but such solutions are often expensive. Systems and methods in accordance with various embodiments of the invention provide a cost-savings approach that tracks the location and/or occupied spaces within a space to maintain a state of the space.

Processes in accordance with numerous embodiments of the invention can track the location and/or occupied spaces by modeling a space as a collection of 3D voxels (or boxes) as an “occupancy grid.” Occupancy grids in accordance with a variety of embodiments of the invention are 3D grids—a set of arrays that are arranged in spatial, 3D organization. In a variety of embodiments, occupancy grids are numeric grids. For example, if coordinate XYZ equals one, this could indicate that the point in space is occupied.

In a variety of embodiments, processes can use state spaces for motion planning. Motion planning in accordance with a number of embodiments of the invention can perform collision avoidance based on occupancy grids and/or projected paths for components in a space. In a variety of embodiments, motion planning can halt a robot before encountering an obstacle and/or plan a trajectory that circumvents any obstacles.

### 2. Plugin Hosts

Plugin hosts in accordance with a number of embodiments of the invention can share resources with and coordinate different elements of a physical hardware system. In several embodiments, plugin hosts can control elements (e.g., robots, welders, etc.) of various different types. In several embodiments, plugin hosts can schedule real-time and non-real-time processes' access to resources and/or operation within a physical space (or cell). Plugin hosts in accordance with a variety of embodiments of the invention can schedule instructions at various cycle rates (e.g., 1000-10,000 Hertz), allowing for high levels of control that are not currently achievable by existing systems.

In some embodiments, plugin hosts can coordinate communications and/or interactions between different robots. For example, when a status goes off-nominal for an individual robot, the robot can be issued a command (e.g., to separate from the other robots) and/or the other robots in the cell can be issued a command. In some cells, it is possible that the reach of the robots could allow collisions with other robots. The control system (e.g., the control architecture) discussed throughout this specification can allow controlling robots in cells while being able to make corrections without stopping work on an article under manufacture. In accordance with several embodiments of the invention, coordination of robots can include instructions (e.g., from planning and control nodes and/or plugin hosts) that utilize a unified coordinate space to control the robots of a cell.

Different robot systems may be implemented in such a way that the commanded positions may be specific to the brand of robot, model of robot, or to the whim of the developer that implemented the plugin for the robot. It could be possible that one robot plugin accepts cartesian commands and another robot plugin accepts joint angles, or joint velocities. In order to flexibly control various components of various types, plugin hosts in accordance with several embodiments of the invention can have high levels of extendibility. In many embodiments, plugin hosts can support many types of hardware such as various robotic systems, various torch systems, various computer systems, various motor control systems, various data acquisition systems and/or various sensor systems. This may be advantageous because it allows control of a system that is configured with varied components from a variety of vendors. Supporting various systems can be advantageous for the ability to swap out different components while reusing most of a codebase. Control architectures in accordance with a variety of embodiments of the invention can also have the capability to control robots of different kinematic configurations. Furthermore, in various embodiments, control architectures can provide fast bus cycles (e.g., 2 ms cycles) sufficient to meet high determinism requirements.

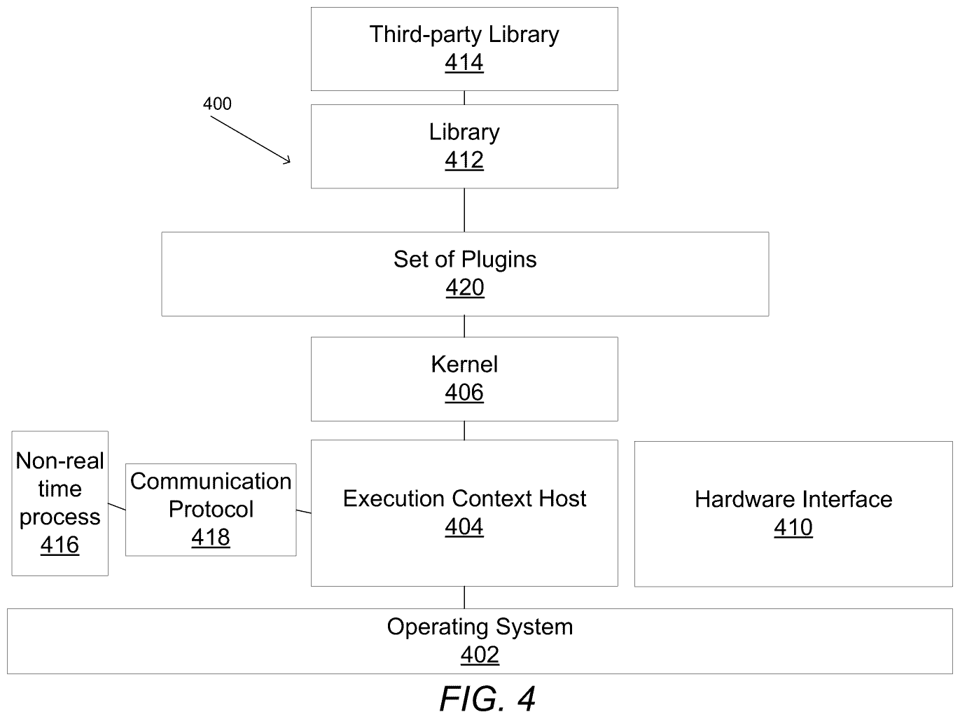

An example of a plugin host for controlling robotic systems is conceptually illustrated in FIG. 4. Plugin host 400 includes operating system 402, execution context host 404, kernel 406, a set of one or more plugins 408, hardware interface 410, library 412, and third party library 414. Plugin host 400 also includes communication protocol 418 for communication with non-real time process 416 and/or robot operating system (ROS) nodes. In this example, execution context host 404 operates on operating system 402 and kernel 406. Plugin host 400 provides access to hardware through hardware interface 410 via plugins 408, which may be accessed via library 412, third party library 414, and/or by non-real-time process 416 and/or ROS nodes (not shown) via communication protocol 418.

Communication protocols in accordance with a number of embodiments of the invention are used to bridge real-time and non-real-time contexts. Examples of communication protocols include data distribution service (DDS), Zenoh, and/or other publish-subscribe frameworks that transact data across network interfaces.

At least one embodiment provides a system capable of communicating directly with hardware manufactured by disparate providers to provide a real-time application for, e.g., robotics control and control of other hardware. The system can operate at the application layer, rather than as an operating system. The inventors recognized the benefit in the foregoing approach, in contrast to having the system operating as a program executed by disparate hardware, in part because the approach minimizes the amount of hardware-specific software customization needed.

Although a specific example of a plugin host is illustrated in this figure, one skilled in the art will recognize that elements similar systems and methods may include additional elements, omit certain elements, combine and/or separate functionality between different elements, etc., without departing from this invention. Examples of elements of a plugin host are described in greater detail below.

a. Real-Time Systems

Certain embodiments utilize a modular system or plug-in architecture that is capable of meeting real-time deadlines.

The approach of these embodiments is uncommon in industry. ROS (Robot OS) and similar projects have a modular framework, akin to a set of software blocks (e.g., a sensor node, a motor node, a motion control node) that are stitched together and executed to control a robot. But ROS is not real time and is not designed for operating industrial equipment, particularly for additive manufacturing at the size and speeds described in U.S. Patent Application Publication No. 2024/0017340, published Jan. 18, 2024, and incorporated herein by reference. The scale and speeds in the aforementioned publication require hard, real-time determinism that prior modular systems do not offer.

The inventors recognized a need for an architecture supporting large-scale, high-speed additive manufacturing with real time determinism. Embodiments can implement a real time approach that does not require writing a real time operating system. Such embodiments can desirably implement a plug-in architecture and a real time process, making use of independently written modules that plug into the real time process. These embodiments can specify which module implements a command at a desired time and repeat that process deterministically at a high cycle rate, such as 1,000 Hz or 10,000 Hz. No ROS application can achieve that at the time of this specification.

Code specific to supporting the modular functionality can be isolated to the abstraction layer, which allows the plug-in functionality to be ported between base environments. The plug-in architecture allows supporting systems outside of additive manufacturing, such as flight vehicle software or ground control software for launch services. Because embodiments of the architecture do not necessarily require an operating system scoped to a specific application, the foregoing approach can extend real time functionality to disparate systems without performance tradeoffs. Accordingly, in some embodiments, plugin hosts can be changed by merely porting an execution context host to a new operating system. By abstracting most functionality into dynamic modules, the architecture described above can be utilized in multiple environments like VxWorks (Wind River Systems, Alameda, California, USA), QNX (QNX Software Systems International, Ottawa, Ontario, Canada), and Integrity (Green Hills Software, Santa Barbara, California, USA) without having to rewrite a substantial amount of code. Rather, the foregoing approach allows for portability by adding support to the plugin host, allowing module-specific code to be ported with little or no modification.

Plugin hosts in accordance with a variety of embodiments of the invention can include one or more operating systems (e.g., Linux and/or Xenomai 3) as primary architectures. In some embodiments, plugin hosts may utilize real-time operating systems (e.g., Xenomai 3 on a Linux kernel or on Mac OS) that can provide high levels of determinism. Operating systems in accordance with many embodiments of the invention can determine, with a high degree of confidence, whether the software has failed to achieve a desired level of determinism. In some embodiments, operating systems may be non-real-time operating systems, allowing for operation on various machines (e.g., development computers, virtual machines, etc.). In some embodiments, plugin hosts can be changed by merely porting an execution context host to a new operating system.

In accordance with several embodiments of the invention, operating systems can be used to provide capabilities of having real time and non-real time threads in the same process. Operating systems in accordance with several embodiments of the invention can exchange data between various non-real time processes and/or ROS nodes via various communication protocols (e.g., DDS, Zenoh, etc.).

b. Execution Context Host

Execution context hosts in accordance with some embodiments of the invention can manage and/or coordinate various processes and instructions. In several embodiments, execution context hosts can receive instructions (or plans) from users and/or various planning and control nodes. Execution context hosts in accordance with many embodiments of the invention can coordinate the instructions from various sources to allocate resources and/or schedule (or coordinate) operations of components of a physical hardware system. In many embodiments, execution context hosts can act as an interface to hardware of a physical hardware system that may be accessed via various plugins, drivers, controllers, libraries, etc. In this way, modules can be developed in isolation of the rest of the platform. This arrangement can also provide the ability to control the execution order, and/or can facilitate sharing of resources and/or communication between the execution context host and plugins for physical hardware systems.

c. Plugins

Again, in several embodiments, plugins can provide modularity by isolating the dependencies on a per-plugin basis. For instance, plugins in accordance with numerous embodiments of the invention can shield users from many of the intricacies of working in an RTOS environment. In several embodiments, plugins can allow provision of a clean environment free of other system-wide dependencies (like Acontis, RTI Connext, etc. libraries) for users. This can be advantageous to reduce development time.

In several embodiments, one plugin type can be a hardware interface provider. For example, plugins can include one or more of the following: A robot plugin (e.g., a KUKA plugin), a welder plugin (e.g., a Fronius plugin - - - Fronius International GmbH, Pettenbach, Austria), an EtherCAT® technology plugin (e.g., an acontis plugin - - - acontis technologies GmbH, Weingarten, Germany), a motor control plugin (e.g., Elmo plugin - - - Elmo Motion Control Ltd., Petach-Tikva, Israel), and/or a sensor plugin (e.g., a Danfoss plugin - - - Danfoss, Nordborg, Denmark). In many embodiments, plugins can be suitable for input/output (I/O) for sensors. Plugin hosts in accordance with various embodiments of the invention can provide multiple instances of a plugin, and/or can have a simulated version of a plugin.

In accordance with many embodiments of the invention, each of the plugins can implement an associated interface. Robot control plugins can implement generic robot arm interfaces. Implementing generic interfaces in accordance with some embodiments of the invention can be beneficial, so that when a new type of robot is added to a system, a common interface is available for the new robot. In many embodiments, different plugins can allow control over different types of robots, even though the user interface can be the same. In several embodiments, plugin hosts can be extended via plugins such that various tools can be controlled by the system. For example, a CNC-as-a-robot plugin can be implemented to run a CNC through plugin hosts in accordance with embodiments of the invention. Plugins in accordance with various embodiments of the invention can be modularly added and/or removed from a robotic additive manufacturing control system by dynamically loading plugin library interfaces.

Plugin hosts in accordance with various embodiments of the invention can include interface nodes, controllers, drivers, and/or plugins. Interface nodes in accordance with various embodiments of the invention can provide an interface for control (e.g., from planning and control nodes, ROS nodes, user interfaces, etc.). In a variety of embodiments, interface nodes can include separate nodes for control of different parts of a cell (e.g., a robot motion planning node and a deposition planning node). In many embodiments, interface nodes can be non-real time interface modes.

Interface nodes in accordance with many embodiments of the invention can interact with controllers that provide an interface for low-level controls for physical hardware. In certain embodiments, controllers for different parts of a system (e.g., a motion system controller and a weld system controller) can communicate via a communication bridge between the controllers. Controllers in accordance with certain embodiments of the invention may control one or more other controllers. For example, motion system controllers in accordance with various embodiments of the invention may control both positioner controllers and/or robot controllers. In a variety of embodiments, positioner controllers can include methods for controlling one or more positioners (e.g., tables configured to position an article relative to a robot). Robot controllers can include methods for controlling one or more robot arms of varying types in accordance with embodiments of the invention. Weld system controllers may control welder controllers. Welder controllers can include methods for controlling one or more welder.

In accordance with several embodiments, robot motion controllers can receive data from weave controllers. In some embodiments, a weave node (e.g., a weave controller) can control weaving during an additive manufacturing process such that textures and/or bump maps can be applied by varying the amplitude of the weave. For non-woven paths, a weave node can apply a displacement weave to a non-woven path).

Plugins in accordance with many embodiments of the invention may interact with drivers (or driver stacks) to interface with hardware. In many embodiments, drivers may include real-time drivers that can be used to enable control of one or more hardware devices within a robotic additive manufacturing system. Drivers in accordance with several embodiments of the invention can encapsulate all data and/or methods needed for device control and/or data extraction. In several embodiments, drivers may inherit methods for a hardware interface (e.g., EtherCAT, CANbus, etc.). Drivers in accordance with a number of embodiments of the invention may inherit methods from generic drivers, which may provide a common interface for devices of a particular type or function. Drivers in accordance with numerous embodiments of the invention may include ELMO drivers, KRC drivers, and/or Fronius TPSI drivers.

In some embodiments, components may include multiple methods for communication including a field bus (e.g., EtherCAT, PROFINET, Ethernet IP, and/or DeviceNet) and/or other protocols (e.g., open platform communications unified architecture (OPC-UA), message queue telemetry transport (MQTT), Internet of Things (IoT), web protocols, etc.). The various interfaces can include real-time (e.g., EtherCAT) and/or non-real-time (e.g., OPC-UA) interfaces. Different interfaces may have different benefits and constraints (e.g., payload limits, speed, compatibility, etc.). Processes in accordance with a variety of embodiments of the invention can communicate with a single component in a system using multiple different interfaces. In a variety of embodiments, each interface is used for a different type of instruction or control.

d. Kernel

Kernels in accordance with certain embodiments of the invention can provide shared resources that plugins and execution context hosts can use to discover each other, discover hardware, and/or use for low-level functions of a target architecture via hardware abstraction. In accordance with various embodiments of the invention, kernels can support open platform communications-unified architecture (OPC-UA) in the kernel. OPC-UA can be used extend data and/or settings access in various machines so that weld parameters can be more finely controlled. In many embodiments, weld parameters can be changed and/or controlled during the course of a print job (e.g., without stopping the print job). In many embodiments, kernels can keep track of hardware interface buses provided by the plugins and/or can coordinate which plugins get access to hardware buses.

In several embodiments, kernels and/or execution context hosts can provide various functions including:
create( ) which can be utilized to initialize the object upon dynamically loading with dlopen( );
read( ) which can read in data/info/state related to the plug-in during an execution loop;
update( ) which can perform state-updates, calculations, and/or data-processing related to the plug-in during the execution loop;
write( ) which can write out data, info, and/or state related to the plug-in and actions the plug-in is taking during an execution loop; and/or
destroy( ) which can clean up resources before dynamically unloading the object.

In several embodiments, kernels can allow deterministic and non-deterministic software to run side-by-side (e.g., as separate processes, or as a common process, etc.) in the same environment. Kernels in accordance with a variety of embodiments of the invention can further run robot sensor interface (RSI) control nodes. RSI control nodes can be configured to stay in contact with one or more robot(s) continuously and/or to respond to any dropout from the other critical nodes on a system.

e. Libraries

In various embodiments, libraries can provide functionality for parsing a file format for paths, constructing RSI XML packets, interpolating robot motion, and/or doing unit/type conversions. These capabilities can be in a library that is used within plugin and/or within the kernel.

In several embodiments, plugin hosts are configured so as to make development easy. Many embodiments include plugin hosts with multiple entry-points for a user to extend the capability of the system depending on the scope of the user's work without having to know the complete system. Scalability can be two-way. This can mean that, in several embodiments, plugin hosts can be suitable for implementation across networks, on multiple different computer systems, and/or on low-resource devices. In several embodiments, control architectures can provide flexibility to run a process on multiple platforms without having to port the entire codebase.

Various embodiments of plugin hosts described herein can be beneficial for applying textures and/or related operations during the print process. In several embodiments, robots can be dynamically controlled to maintain and/or adopt a toolpath. The dynamic control can be based on sensor inputs. This approach can utilize a robot sensor interface (RSI).

While specific examples of plugin hosts are described above, any of a variety of systems can be utilized as appropriate to the requirements of specific applications.

### 3. Physical System Hardware

In some embodiments, a robot-based additive manufacturing cell can be capable of supporting multiple robots of varying configurations (e.g., one or more robots and/or components with different manufacturers, numbers of axes, robotic reach, and/or positions), multiple manufacturing operations and/or methods (e.g., metal printing, plastic printing, measurement, inspection, machining/subtractive operations), using control architectures. Robot-based additive manufacturing cells in accordance with a number of embodiments of the invention can include one or more (e.g., a swarm of) individual robotic agents operating on a shared workpiece.

In several embodiments, different components (or robots) of physical hardware systems can directly provide information regarding their state to planning and control nodes. Alternatively, or conjunctively, robot states may be determined through external channels (e.g., sensors, other monitoring elements, etc.). In many embodiments, robot agent states can be monitored to reduce downtime. In several embodiments, control systems can generate, monitor, and/or update robot health states. Health states can be associated with particular robots and/or with particle robotic cells. Health states can include statuses related to wire supply nozzle buildup, robot calibration, robot location, robot velocity and/or other statuses.

In accordance with many embodiments, robot agent states can be beneficially used for collision avoidance (e.g., collisions between a first robot and a workpiece, between a first robot and itself, and/or between a first robot and a second robot), timing wire spool replacement, and/or other processes. In several embodiments, a score-based planner can be implemented. Score-based planners can increase the chance of successfully generating a part by evaluating several operation options. A selection of an operation option can be based on a score. In some embodiments, operation options can include stopping a print job, adding material, and/or changing a toolpath. Scores can be determined based on an amount of wire remaining, and/or a collision imminent detection.

Many embodiments of control systems can be capable of controlling robotic systems to use multiple print heads to contribute to a single workpiece (e.g., article). Each robot can be capable of performing multiple operations. Robots can incorporate sensors. Sensors can be interfaced with control architectures in accordance with some embodiments of the invention.

While specific examples of physical system hardware are described above, any of a variety of hardware systems can be utilized as appropriate to the requirements of specific applications.

### 4. Perception Nodes

In several embodiments, perception nodes can be used to measure and/or monitor the state of one or more elements of a workspace (or cell). Perception nodes in accordance with a variety of embodiments of the invention can include motion capture systems, laser scanners, monitoring robots, and/or inertial measurement units. Perception nodes in accordance with a variety of embodiments of the invention can collect sensor data and/or sensor topology to generate state estimations of robots and/or articles under manufacture. Perception nodes in accordance with certain embodiments of the invention can determine deviations from an intended geometry based on measured states. Measured states can include measurements of dimension (e.g., position, thickness) versus time. Comparison of measured states to time dimensions can be utilized to map measured states to an intended geometry. Measured states can include temperature, voltage and/or current measurement, tool angle, table pose, and/or travel speed. Temperature can be used for determining weld quality. Voltage and/or current measurements (e.g., high-speed voltage and/or current measurements) can be used for driving defect/anomaly detection. Perception nodes in accordance with a number of embodiments of the invention can provide data indicative of measured states in accordance with many embodiments of the invention.

### 5. Visualization Environment

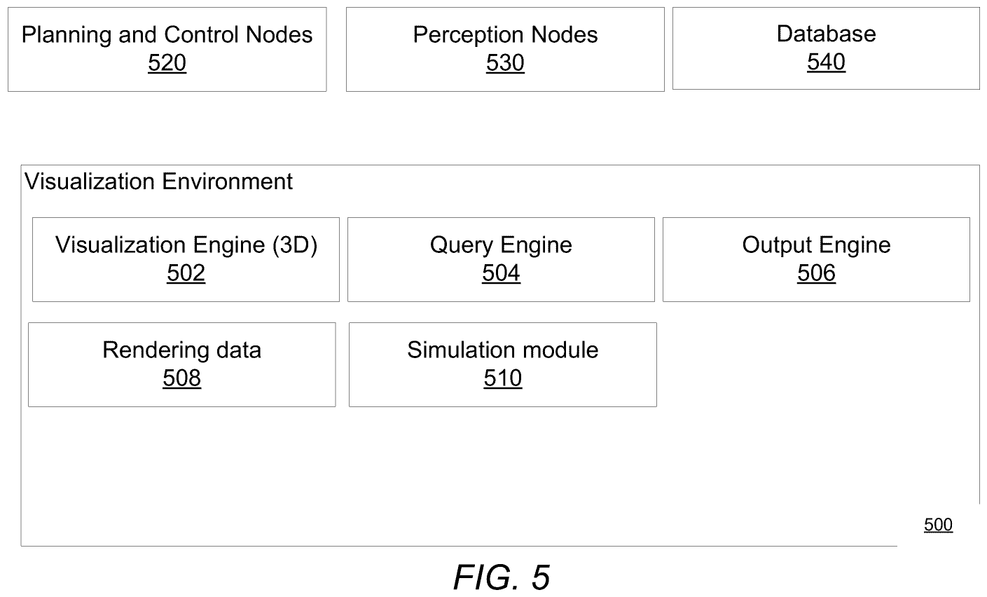

In a number of embodiments, visualization environments can visualize print paths, printed parts, etc. Visualization environments in accordance with a variety of embodiments of the invention visualize, verify, and/or deploy print processes in one or more print cells. An example of a visualization environment in accordance with an embodiment of the invention is illustrated in FIG. 5. Visualization environment 500 includes visualization engine 502, query engine 504, output engine 506, and simulation module 510.

Visualization environments in accordance with some embodiments of the invention can be used to visualize elements in a space (e.g., a print cell, across multiple print spaces, etc.). In a variety of embodiments, visualization environments can render spaces based on rendering data 508 from various sources, such as (but not limited to) planning and control nodes 520, perception nodes 530, and database 540. For example, planning and control nodes in accordance with some embodiments of the invention generate tool paths for actual (or simulated) print cells that can be used to visualize a print job. Tool paths in accordance with various embodiments of the invention can be stored as tool path files and/or streamed (e.g., from a control system to a robot or visualization environment) without being separately stored. In a variety of embodiments, simulations can be generated at external planning and control nodes and/or simulation modules 510 of the visualization environment.

In numerous embodiments, visualization environments render a visualization of robot movement through a space using the same inputs that are used to control the robots from the planning and control nodes. Such visualizations can be used to visualize potential collisions and/or a target (or desired) outcome, which can be compared to data from an actual print job (e.g., sensed data) to identify potential problem areas. Perception nodes in accordance with various embodiments of the invention can provide various data that can be overlayed on a printed part or within a space, such as (but not limited to) point cloud data, laser scanner data, robot state data, etc.

In certain embodiments, rendering data can include print data (e.g., from databases) that can be used to render data from previous print jobs that may be recorded during a print session. Print data in accordance with a variety of embodiments of the invention can include detailed process monitoring data about a print job and/or about multiple points during a print job, such as (but not limited to) Tool Center Point (TCP) positions, axis position data, arc voltage data, temperature data, weld parameters, etc. In a variety of embodiments, print data includes data from simulated and/or visualized print jobs. Examples of planning and control nodes, perception nodes, and databases are described throughout this description (e.g., with reference to FIGS. 1-3).

Visualization engines in accordance with various embodiments of the invention can use rendering data to generate renderings of various elements in a space. Elements in accordance with various embodiments of the invention can include (but are not limited to) robots, robot arms, print heads, printed parts, print (or tool) paths, print tables, obstructions in a space, etc. Print paths (or tool paths) in accordance with numerous embodiments of the invention indicate the path of a printer (or other element) in space over time. In a variety of embodiments, elements may include actual and/or simulated elements in a physical and/or virtual space. Visualization engines in accordance with several embodiments of the invention can provide various renderings of elements that may reflect different characteristics of elements (or portions thereof), such as (but not limited to) location in physical space (e.g., x, y, z coordinates), print material, simulated surfaces, print temperatures, weld parameters, material codes, etc. In a number of embodiments, visualization engines can provide renderings of multiple overlapping elements and/or deltas between them.

In certain embodiments, visualizations can be used to identify potential collisions or other errors (e.g., deviations from the target (or desired) path). In several embodiments, collisions can be rendered in a variety of ways, such as (but not limited to) as overlapping elements, error notifications, etc. For example, visualization engines in accordance with a number of embodiments of the invention can render one or more versions of a part or tool path and/or deltas between them, such as (but not limited to), an original plan, a target path, a compensated plan, a previously completed print job, paths from a live session, etc.

In various embodiments, visualizations can compare an actual live print job (e.g., from a control system) with a rendered target print job (e.g., from a visualization environment) as a sort of “digital twin” of print spaces and/or printed parts. Digital twins in accordance with numerous embodiments of the invention can be used to identify deltas between target and actual (live or saved) print jobs for live or offline visualizations. Renderings of different versions of elements in accordance with many embodiments of the invention may be displayed in different ways (e.g., different colors, textures, layers, etc.). In certain embodiments, digital twins are representations of real physical objects or spaces, with sufficient fidelity to convey accurate and timely status to a user. In a variety of embodiments, users can manipulate (e.g., rotate, translate, view, inspect, etc.) a represented digital twin and/or a visualization of a printed part to view different perspectives of the part. Visual environments in accordance with numerous embodiments of the invention allow a user to operate (e.g., start printing, stop printing, update a path, etc.) a represented digital twin of a print cell to remotely control a physical print space, almost as though a user were standing in the physical presence of the robots and inter-process communication (IPC).

Visualization engines in accordance with a number of embodiments of the invention are 3D rendering engines (e.g., Qt 3d renderer). 3D rendering engines in accordance with a number of embodiments of the invention utilize render graphs. Render graphs are structures that control render outputs on a display based on available data and graphic effects (e.g., lights, cameras, materials) that may be enabled. 3D rendering engines in accordance with certain embodiments of the invention can utilize one or more render paths, such as (but not limited to) basic forward renderers, renderers with shadow effects, HDR renderers, etc. In some embodiments, 3d rendering engines support picking to identify a selected part of an object.

Traditionally, picking in 3D works by tracing rays from the 2D clicked point into the 3D scene and calculating which objects were intersected. This is useful when selecting whole objects but doesn't work to determine which exact part of a single object was selected. Therefore, processes in accordance with many embodiments of the invention use pixel-precise, image-based picking. Picking in accordance with several embodiments of the invention can be performed using object IDs (or pick IDs) that are output a separate picking texture. When a mouse click is detected, processes in accordance with some embodiments of the invention can identify values (RenderCapture objects) of the pixel under the mouse from the picking texture and identify the associated object based on the pick ID. Processes in accordance with several embodiments of the invention output color and pick ID simultaneously (or multiple render targets). In a variety of embodiments, pick ID is a 32-bit integer but the picking texture has four 8-bit channels. Processes in accordance with many embodiments of the invention pack 32-bit integers into 4 channels, and convert the values of the 4 channels back to a 32-bit integer to identify the pick ID.

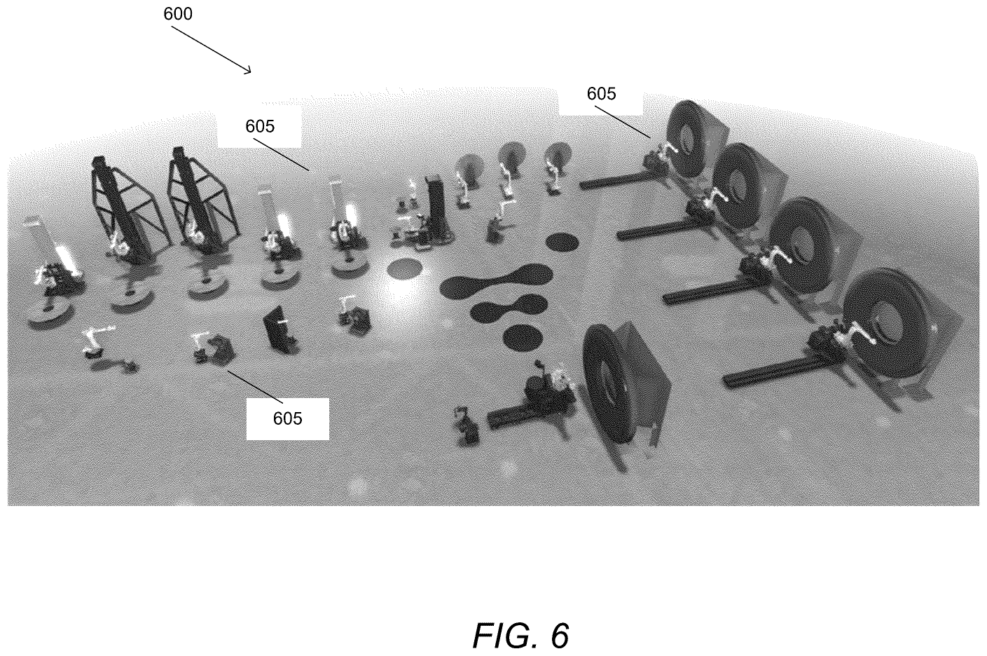

In various embodiments, query engines can query databases to retrieve various rendering data, such as (but not limited to) print data, robot data, materials data, etc. In several embodiments, output engines can generate renderings for display on one or more systems, such as (but not limited to) augmented reality systems, virtual reality systems, monitor displays, etc. Examples of a user interface (UI) in accordance with several embodiments of the invention are illustrated below with reference to FIGS. 6-14.

An example of a visualization UI that illustrates a visualization of multiple print spaces in accordance with an embodiment of the invention is illustrated in FIG. 6. In this example, several print cells 605 with different types of robots at varying points of progress are illustrated. In some embodiments, each print cell may be selectable to provide a more detailed view of an individual print cell. The entire multiplicity of print spaces may represent a digital twin of an entire print factory, and each of the several print cells 605 may represent a digital twin of the respective cell. In various embodiments, portions or all of robotic additive manufacturing cell 100 discussed above can be visualized as a print cell 605.

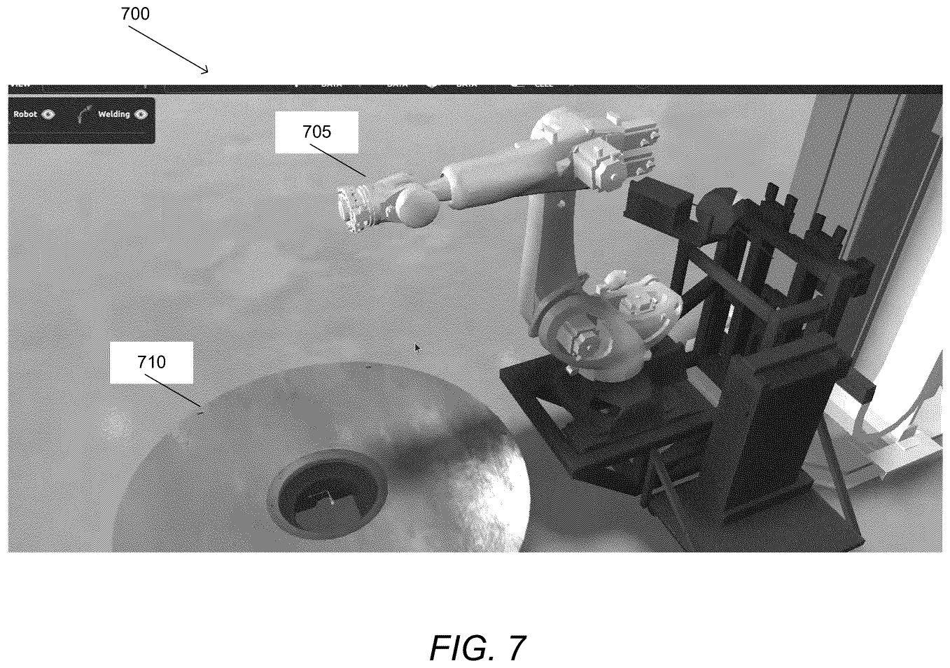

An example of a visualization UI that illustrates visualizations of a print cell in accordance with an embodiment of the invention is illustrated in FIG. 7. This example illustrates a robot 705 and a print table 710. In this example, robot 705 is rendered based on robot data. Robot data in accordance with certain embodiments of the invention can include (but is not limited to) arm length, angles, robot type, robot path data, configuration data, connection (e.g., lift, rail, etc.), base width, 3D model data, etc.

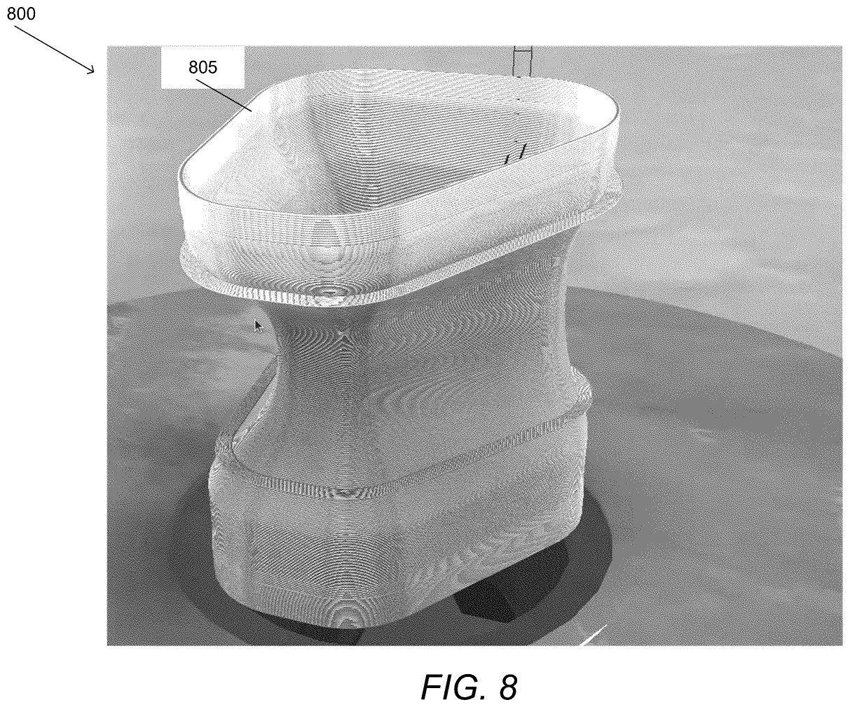

An example of a visualization UI that illustrates a printed part visualization in accordance with an embodiment of the invention is illustrated in FIG. 8. This example illustrates a UI 800 with a close-up view of a printed part 805. The printed part illustrates many layers of the printed part. In several embodiments, visualizations may include detailed information about individual points during the print job of the printed part as a part of a point data interface. Visualizations in accordance with some embodiments of the invention create precise geometric representations of printed parts based on information in the toolpath data (e.g., layer height, wall thickness, etc.).

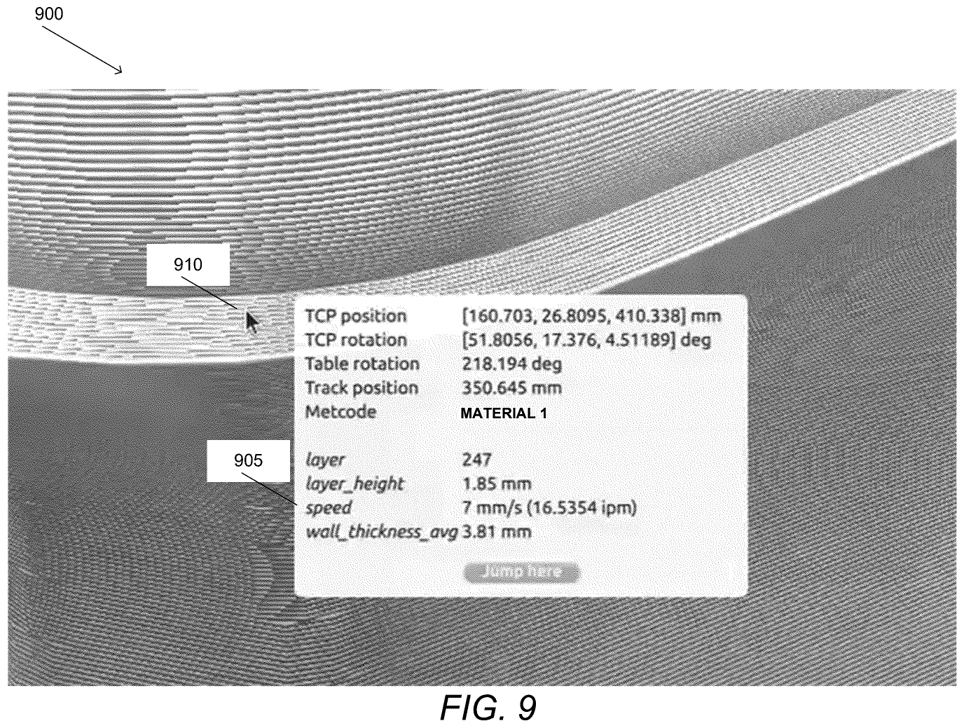

An example of a visualization UI that illustrates a point data interface in accordance with an embodiment of the invention is illustrated in FIG. 9. In various embodiments, visualization UIs allow for interaction with a part to display process monitoring data specific to a selected point on the part. In this example, visualization UI 900 includes UI element 905, which illustrates process monitoring data at selected point 910. Process monitoring data in accordance with many embodiments of the invention includes (but is not limited to) position, weld parameters, material codes, speed, layer height, table rotation, track position, etc.

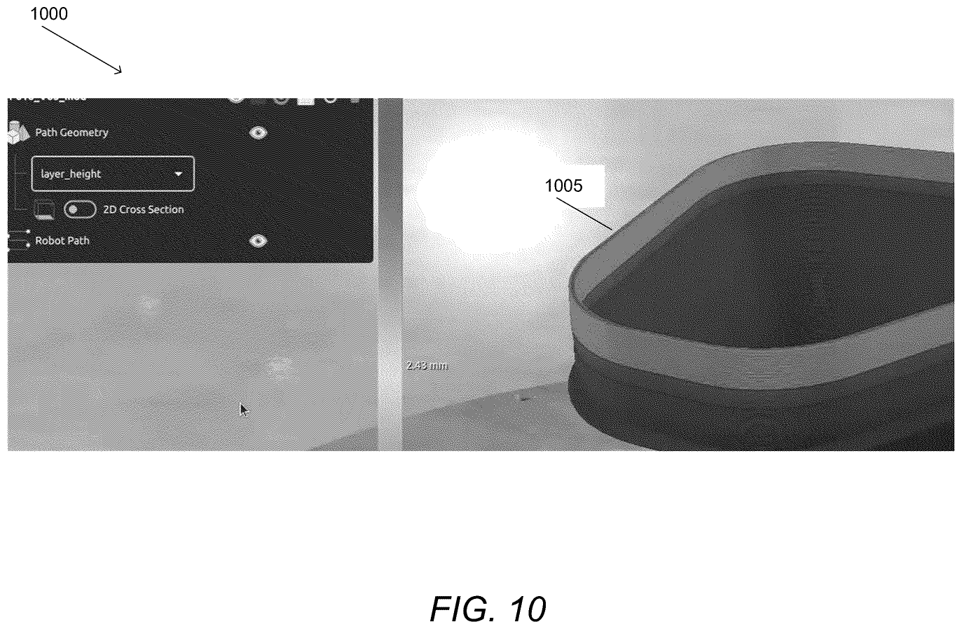

An example of a visualization UI that illustrates layer heights of a print job shown in a render in accordance with an embodiment of the invention is illustrated in FIG. 10. Visualization UI 1000 illustrates a printed part, similar to the printed part of FIG. 10, with different layers of a printed part 1005. However, in this example, rather than a rendering of the materials making up the part, the visualization illustrates layers in different colors based on layer height, with darker colors representing taller layers. Various characteristics of different portions of a print job may be illustrated, including (but not limited to) weld parameters, print variables, process monitoring data, etc.

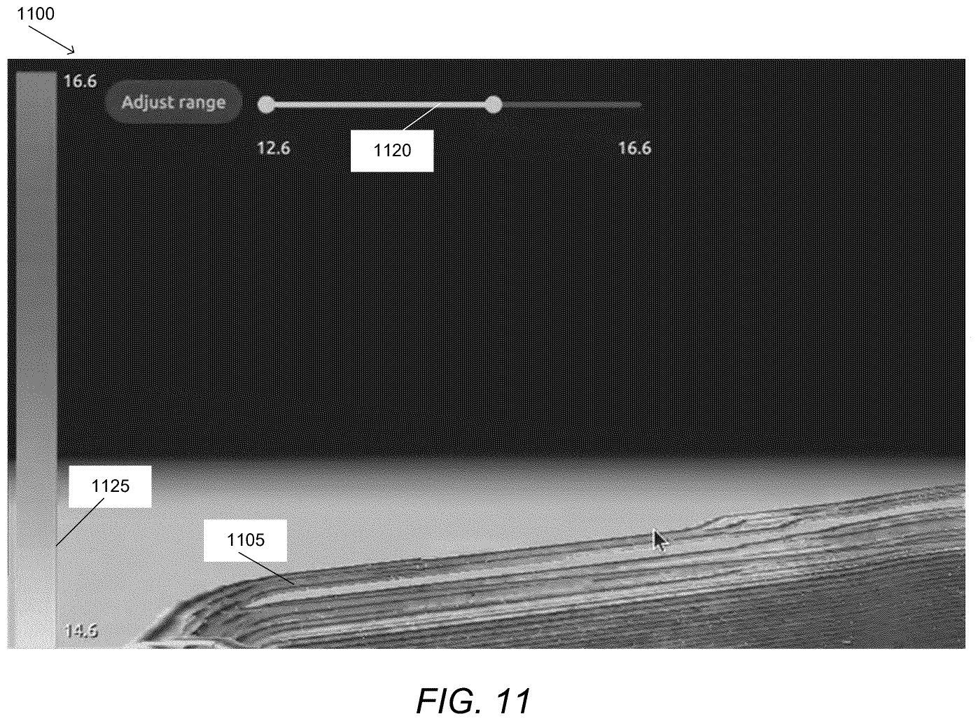

An example of a visualization UI that illustrates process monitoring data for sections of a print job in accordance with an embodiment of the invention is illustrated in FIG. 11. In this example, UI 1100 indicates weld voltage in different colors throughout the printed part 1105. Unlike the previous example, there is variation within each layer and values fall within a range, providing for a gradient of colors at different points of the print job. One skilled in the art will recognize that similar systems and methods can be used to visualize characteristics at various levels of abstraction (e.g., layers, points, sections, pieces, etc.) without departing from this invention.

This example further illustrates a slider control 1120. Slider tools in accordance with several embodiments of the invention can allow a user to set a range of values to be displayed in a visualization. Slider control 1120 maps the range of colors 1125 to the range from 12.6 to 16.6. Allowing the range to be adjusted can allow a user to exclude outliers or to focus on variations of a print job within a smaller range, where the variations may otherwise be washed out when the range is too large.

In many embodiments, visualization environments can provide for visualization of a print job as it happens. Visualizations of a print job in accordance with many embodiments of the invention include live play of a (simulated or actual) print job, playback of a historical print job, trick play (e.g., pausing, skipping, modified play speeds, etc.) of a print job, etc. In several embodiments, visualizations of a print job may switch from live play to playback of an ongoing print job when pausing or skipping back in time for a visualization of the ongoing print job.

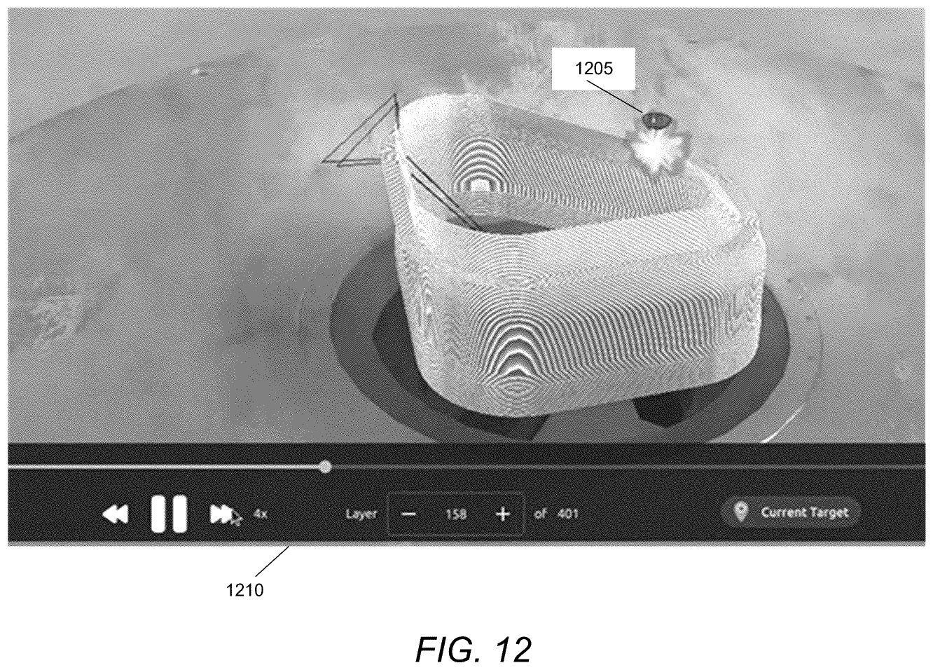

An example of playback of a print job in accordance with an embodiment of the invention is illustrated in FIG. 12. In this example, the print head 1205 is shown laying down new material on the printed part. In a variety of embodiments, visualization UIs may include trick play controls (e.g., speed, pause, play, progress slider). In this figure, trick play controls 1210 are shown along the bottom of the screen. Trick play controls 1210 include controls to play, rewind, fast forward, and control the speed of playback. Trick play controls 1210 also include controls to skip back and forth through a timeline for the print job and to skip to different timestamps (e.g., different layers) during the print job. In certain embodiments, trick play controls can be used during a live print job to move a playhead back in time (along the timeline) for the print job and to move the playhead forward in time up to the time of the live print job.

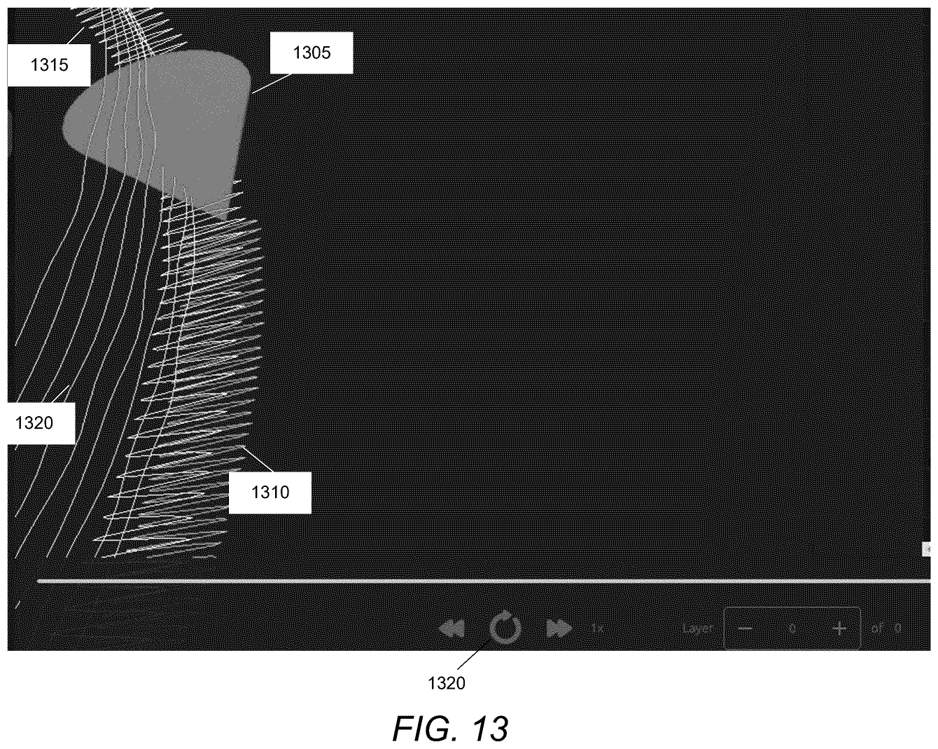

An example of a simplified UI for playback of a print job is illustrated in FIG. 13. In this example the print table and robot are not shown at all, but rather a simplified view of the print head 1305 and the print paths 1310 and 1315 are shown. In this example, print path 1310 is a live print path, while print path 1315 is a target path. Print paths 1310 and 1315 are illustrated with wave-like lines to indicate a print path necessary to print a thick wall, spreading the material over a larger area. This figure also includes a future portion 1320 of print path 1310, which represents upper layers of the print plan that have not been printed yet. By illustrating the paths in different colors, small variations can be seen and adjustments to the print path can be made. In several embodiments, visualization UIs may allow for various elements to be shown or hidden, allowing a user to focus on whatever is important at the time.

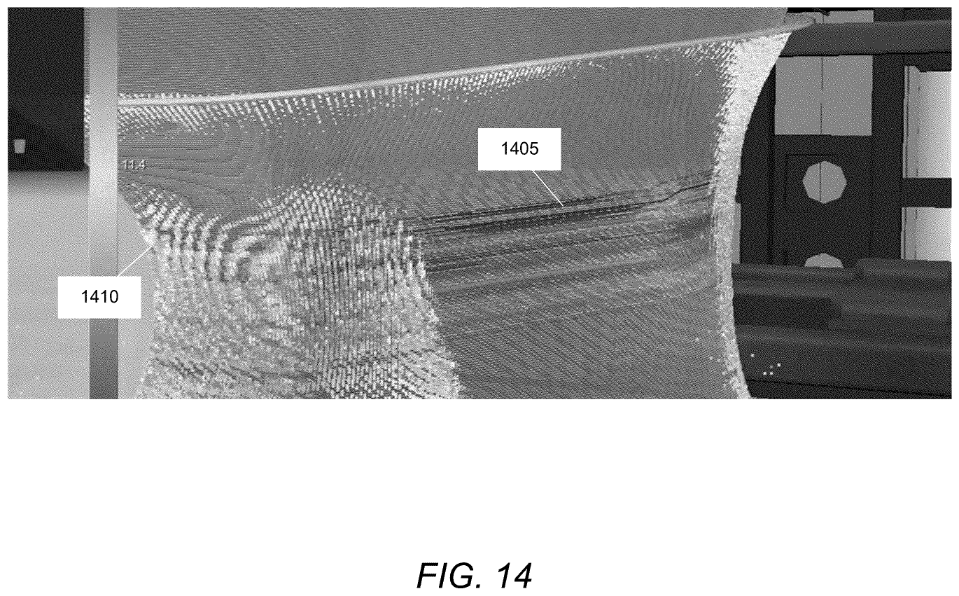

An example of a visualization UI that illustrates a render of different aspects of a printed part in accordance with an embodiment of the invention is illustrated in FIG. 14. In this example, in addition to the gradient 1405 of colors indicating changes in the weld voltage, point cloud data from a laser scanner is overlaid 1410 on the visualization to indicate sensed data within the print cell. In a variety of embodiments, different aspects (or characteristics (e.g., sensor data, process monitoring data, material data, etc.)) can be rendered using different visual cues, such as (but not limited to), colors, directional arrows, textures, height, width, etc.

### Control Process

Control systems in accordance with certain embodiments of the invention can be capable of autonomously planning additive, subtractive, measurement and/or inspection tasks. Control systems can enable advanced synchronization of synergic lines for multiple welders, and/or encoding/modulating signals. In some embodiments, defect detection can be used as a factor for scoring task planning. Deposition (e.g., welding) processes can be controlled based on parametric strategies that have sensor-driven closed loop controls in accordance with many embodiments of the invention.

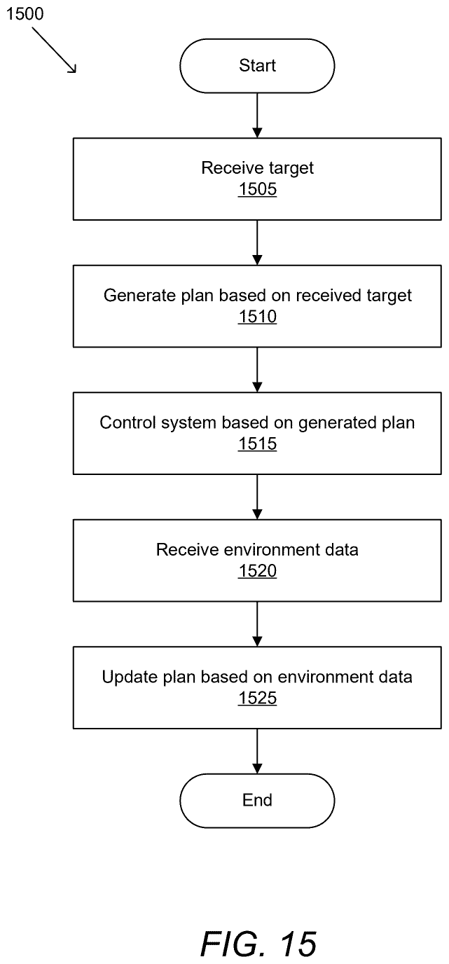

An example of a process for dynamic control in accordance with an embodiment of the invention is illustrated in FIG. 15. Process 1500 receives (1505) a target. Targets in accordance with some embodiments of the invention can include target plans, input geometries, trajectories, and/or coordinated interactions between robots of a system. Input geometries in accordance with a number of embodiments of the invention can take many forms, such as at least STEP, AP242, and/or hulled walls.

Process 1500 generates (1510) a plan based on the received target. Generating a plan in accordance with a variety of embodiments of the invention may be based on various factors, including simulations, sensor data, state estimations, etc. Simulations in accordance with several embodiments of the invention can be performed based on the received target, sensed data, etc. In several embodiments, simulation can include simulation of robot positions, deposition systems, and/or article manufacture.

In several embodiments, simulation can be an online weld simulation. Predicted states of articles can be informed by online weld simulations. Online weld simulations can be based on initial predictions. Initial predictions in accordance with some embodiments of the invention can be based on measurements relative to a baseplate. Incremental predictions can be generated based on previous measured states and/or online weld simulations. Incremental predictions can be used to determine and/or output a health parameter of top layers and/or outer layers. The health of the top layer and/or outer layer can be based on a comparison of an intended geometry of an article to the incremental predictions of the actual current and/or future state (e.g., geometry) of the article. Determining the future state of the article can be important to account for thermal expansion when comparing current geometry to intended geometry.

In certain embodiments, simulations and/or input geometries can be used to generate plans on a layer-by-layer (e.g., sliced) basis. Processes in accordance with some embodiments of the invention can generate a print plan. Print plans in accordance with some embodiments of the invention can be generated based on a sliced geometry, based on an article state estimate, and/or based on robot telemetry. In several embodiments, print plans can be generated using density and rate-of-turn analysis. In accordance with various embodiments of the invention, print plans can include plans for one or more deposition systems to work in concert.

Process 1500 controls (1515) a physical hardware system based on the plan. Controlling a system in accordance with many embodiments of the invention can include scheduling and/or coordinating multiple robots, modifying parameters (e.g., torch temperatures, locations, poses, etc.) for individual robots, etc. In certain embodiments, controlling a system can include converting a set of non-real-time instructions to a set of real-time instructions. Controlling a system in accordance with several embodiments of the invention can include allocating resources amongst multiple robots.

Process 1500 receives (1520) environment data. Environment data in accordance with a variety of embodiments of the invention includes various information about an environment, such as motion data, robot telemetry data, pose data, state data, sensed data, etc. In some embodiments, environment data can include simulated or predicted data, which may be based on sensed data from the environment.

In a variety of embodiments, environment data can include part state estimates based on sensed data. In several embodiments, sensed data can be received from sensors mounted in a manufacturing cell and/or on a manufacturing robot. Robot telemetry data can include position, reach and/or constraints on one or more robots.

Part state estimates in accordance with some embodiments of the invention can include rendering of the expected resulting part based on a current plan. In accordance with embodiments of the invention, 3D rendering can be performed using multiple levels of detail depending on proximity of a section to being printed. This can effectively speed up rendering of portions of an article that will not be printed for some time far from the current time. Such distant portions can be rendered using lower-quality (e.g., easier to render) geometry and/or textures. In several embodiments, measurements of the workpiece have varying levels of quality due to sensing constraints like occlusion, angle, temperature variation, and/or lighting conditions. One or more of such measurements can be used to determine a quality metric for the data. The quality metric of different data can be used as a weighting factor for determining a state estimation of the article and/or of one or more robots.

Process 1500 updates (1525) the plan based at least in part on the environment data. Environment data in accordance with many embodiments of the invention can include simulation data, part state data, cell state data, motion data, location data, visualization data, etc. State data in accordance with some embodiments of the invention can be estimated based on various environment data.

In some embodiments, control systems can have live (or dynamic) updating of tool paths. For example, in several embodiments, multiple previous weld beads can be tracked, and new path plans can be generated so that material can be deposited in tight concentric paths to build up thickness and reduce porosity. In some embodiments, controlling a physical hardware system can include other dynamic updates, such as collision avoidance, coordinated actions for robots, tables, sensors and/or welders, etc.

Article (e.g., workpiece) state estimation, in some embodiments, can be used to determine where to add material and/or how to add material. This can be beneficial for facilitating corrective actions. For example, distortion compensation can be achieved by controlling weld parameters such as a tool angle at restart. In several embodiments, tool path plans can be controlled so as to adjust print characteristics such as heat input (e.g., heat input density or heat input to a particular region of a part over an amount of time). Heat input and/or heat input density can also be controlled by controlling deposition system travel speed and/or wire feed speed in accordance with several embodiments of the invention.

In accordance with many embodiments of the invention, corrective actions can be taken when conditions are met. A condition can be a sufficient deviation from an intended geometry. Corrective actions can include adjusting parameters to correct incoming layer of material. Adjusting parameters can include running a torch hotter, spindling down waviness of a print job, stopping printing, removing material (e.g., through conventional removal techniques), adjusting tool path-plans to bring a print job back to tolerance, prepping surfaces for adding material, scanning sections of robots to perform self-maintenance, and/or cleaning print nozzles.

Updating plans in accordance with many embodiments of the invention can include adding and/or removing robots from cells (e.g., robotic additive manufacturing cells). Processes in accordance with a number of embodiments of the invention can be capable of adding a robot into a cell and immediately controlling that robot to contribute to an article under manufacture without stopping the print job. This functionality is enabled by the interoperability of control systems in accordance with many embodiments of the invention.

### Visualization Process

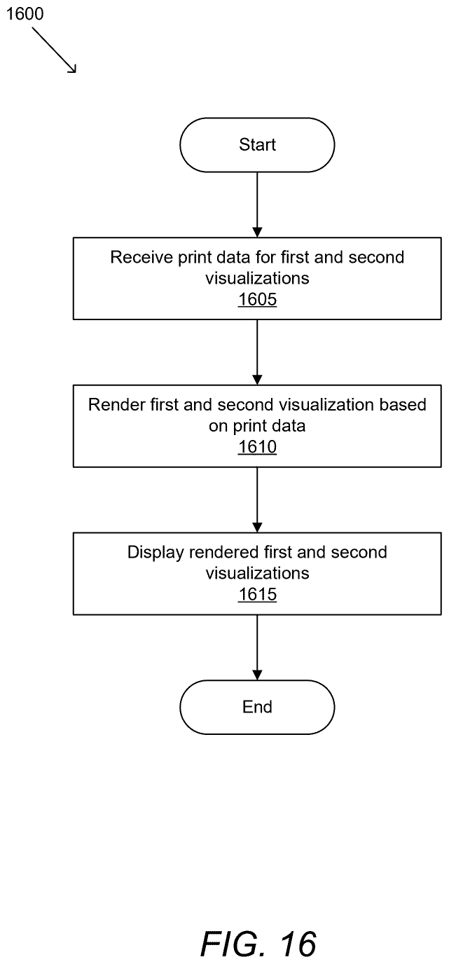

Visualization environments in accordance with many embodiments of the invention can provide various visualizations of a manufacturing process. An example of a process for multiple visualizations is conceptually illustrated in FIG. 16. Process 1600 receives (1605) print data for multiple visualizations. In a number of embodiments, print data includes data received from a control system that controls a set of one or more robots to print a part. Print data in accordance with some embodiments of the invention includes data for a print job through a given timestamp. In certain embodiments, print data is streamed to a visualization environment as it is generated (e.g., by a control system) and the visualizations are continuously updated. Examples and other details of print data are found throughout this specification.

Process 1600 renders (1610) the multiple visualizations based on the print data. In many embodiments, print data includes robot data for the set of robots and rendering the visualizations includes rendering representations of the set of robots. Robot data in accordance with various embodiments of the invention includes various data about the robots, such as (but not limited to) arm length, arm angle, robot type, configuration data, robot connections, base width, and 3D model data. In some embodiments, processes render visualizations based on various computations, including (but not limited to) physics engines, robot configurations, etc.

Process 1600 displays (1615) the rendered visualizations. In certain embodiments, rendered visualizations can be displayed in various display systems, such as (but not limited to) augmented reality systems, virtual reality systems, monitor displays, etc. Processes in accordance with several embodiments of the invention display the rendered visualizations as overlapping elements and/or deltas between them. In some embodiments, processes display other print data associated with the visualizations as text, different colors, textures, etc.

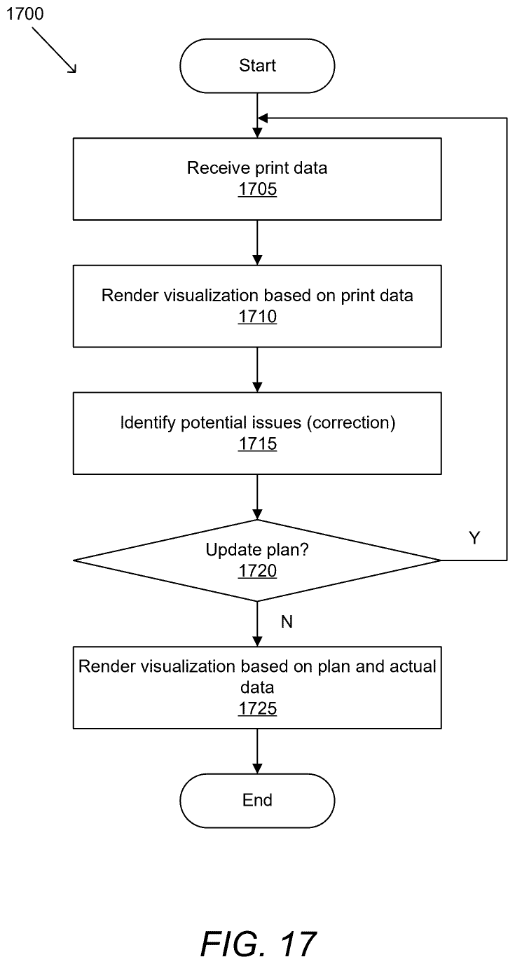

An example of a process for visualizing a manufacturing process in accordance with an embodiment of the invention is conceptually illustrated in FIG. 17. Visualizing manufacturing processes in accordance with various embodiments of the invention can be used to optimize a toolpath to improve a printed part (e.g., reduce manufacturing variances, avoid print errors, etc.).

Process 1700 receives (1705) print data. Print data in accordance with certain embodiments of the invention can include (but is not limited to) data of actual print paths, simulated print paths, corrected/compensated models, scene data (e.g., robot data, print cell data, etc.), plan data, tool paths, process monitoring data, etc. In some embodiments, print data may include data about live print jobs in one or more print cells of a print environment. Print data in accordance with some embodiments of the invention includes data for a print job through a given timestamp. In certain embodiments, print data is streamed to a visualization environment as it is generated (e.g., by a control system) and the visualizations are continuously updated. Print cell data information in accordance with several embodiments of the invention can include print cell configurations that may include positioning data within a print cell of robots, sensors, etc. Print data in accordance with numerous embodiments of the invention can include (but is not limited to) sensor data (e.g., point clouds, scanner data, motion data, pose data, robot state data, etc.), robot positioning data (e.g., coordinate data, robot model data, etc.), process monitoring data (e.g., TCP positions, axis position data, arc voltage data, temperature data, weld parameters, etc.), etc. In several embodiments, print data may be received via one or more protocols (e.g., ROS, Data Distribution Service (DDS), etc.). Many embodiments also include data for previously completed print jobs that may be replayed. Examples and other details of print data are found throughout this specification.

In some embodiments, processes can use print data to compute robot movements for visualizations. For example, processes in accordance with some embodiments of the invention can receive print data indicating elements of a space (e.g., robots in a print cell, people, print tables, printed parts, etc.) and uses data about the elements to determine how each element appears and/or how it should be positioned and/or moved within the space.

Print data in accordance with numerous embodiments of the invention can include sensed data for a print job (whether live, simulated, or a saved historic print job). Sensed data in accordance with some embodiments of the invention includes (but is not limited to) point cloud data, laser scanner data, audio data, video data, motion data, etc.

Process 1700 renders (1710) visualizations based on the print data. In certain embodiments, rendering includes identifying model robot data (e.g., arm length, angles, robot type, connection (e.g., lift, rail, etc.), base width, 3D model data, etc.) that can be used to render the robot in 3D space. Rendering visualizations in accordance with several embodiments of the invention includes rendering data from databases, control systems, perception nodes, and/or other data sources.

In several embodiments, processes render updates to the visualization over time. For example, when visualizing a print job, processes may emulate beads as they are laid down during a print job. In some embodiments, visualization environments may visualize beads and/or layers as they are laid down by a print head. Processes in accordance with several embodiments of the invention may use factors (such as, but not limited to) layer heights, wall thicknesses, and material codes to generate geometry approximations of a printed path as the print progresses. Visualization environments in accordance with some embodiments of the invention update visualizations of beads and/or layers over time. For example, processes in accordance with a variety of embodiments of the invention update visualizations of beads to show changes in the shape (e.g., as the material cools).

In a number of embodiments, rendering visualizations includes physics-based adjustments. For example, processes in accordance with numerous embodiments of the invention can use physics-based oscillation models to account for a robot that may shake while printing a weaving path. In certain embodiments, simulations model acceleration and/or deceleration of robots. Modeling acceleration and/or deceleration can lead to more precise estimates in printing time and/or the ability to detect if the prescribed robot move is possible or would cause a collision.

Process 1700 identifies (1715) potential issues based on the rendered visualizations. In certain embodiments, identifying potential issues can include mapping defects onto a rendered surface. For example, processes in accordance with several embodiments of the invention may detect defects (e.g., during or after a print job and/or after a visualization) and map the defects to portions of rendered visualizations. In many embodiments, detected defects can be correlated with environmental variables (e.g., weld parameters, environmental conditions, etc.) during the print job.

Process 1700 determines (1720) whether to update a print plan based on the identified potential issues. In certain embodiments, updating print plans can be an iterative process, modifying various sets of variables in a print plan to determine an optimal plan.

When the process determines that the plan is to no longer be updated, process 1700 renders (1725) visualizations based on the plan and actual data. In many embodiments, visualizations based on the plan and actual data are visualizations of a live print job. Visualizations based on the plan and actual data in accordance with some embodiments of the invention are playback visualizations of a historic print job. In a number of embodiments, visualizations can be done during a live print job and then further visualized again post-print. Post-print visualizations in accordance with a variety of embodiments of the invention may include additional data that may not be available during a live print job (such as, but not limited to, some scanner data, post-print analysis data, finalized print data, etc.).

In this paper, the words “including,” “such as,” “e.g.,” and related terms are not closed-ended and should be interpreted as having the explanatory language “but not limited to.” Likewise, the term “include” is not closed-ended and should be interpreted such that what proceeds is not limiting on the term that precedes.

While specific processes for controlling robot systems and visualization environments are described above, any of a variety of processes can be utilized to control hardware systems as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to manufacturing processes, the techniques disclosed herein may be used in any type of robotic process.

While specific architectures, assemblies, components and/or systems for robotic additive manufacturing are described above, any of a variety of assemblies, components and/or systems can be utilized for robotic additive manufacturing as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are sometimes described in reference to robotic additive manufacturing, the techniques disclosed herein may be used in any type of robotics control system. The techniques disclosed herein may be used with any of the additive manufacturing assemblies, components, systems, methods and/or processes as described herein.

What is claimed is:

1. A method for visualizing a space, the method comprising:
receiving, at a set of one or more processors, a set of print data, wherein the set of print data comprises:
a first set of data for a first visualization, wherein the first set of data is received from a control system that controls a set of one or more robots for a print job to print a part; and
a second set of data for a second visualization associated with the part;
rendering, at the set of processors, the first and second visualizations based on the print data, wherein the first visualization comprises a visualization of the print job; and
displaying the rendered first and second visualizations.

2. The method of claim 1, wherein the first set of data further comprises robot data for the set of robots and rendering the first visualization comprises rendering representations of the set of robots.

3. The method of claim 2, wherein the robot data comprises at least one selected from the group consisting of arm length, arm angle, robot type, configuration data, robot connection, base width, and 3D model data.

4. The method of claim 1, wherein the first visualization and the second visualization differ in at least one selected from the group consisting of color and texture.

5. The method of claim 1, wherein:
the set of robots comprises a plurality of robots; and
displaying the rendered first and second visualizations comprises displaying potential collisions between the plurality of robots.

6. The method of claim 1, wherein the set of print data comprises a print material for the part and rendering the first visualization comprises rendering a texture based on the print material.

7. The method of claim 1, wherein the set of robots are simulated robots in a virtual space.

8. The method of claim 1, wherein:
the set of robots are in a physical space;
the second set of data comprises sensed data from the physical space; and
rendering the second visualization comprises rendering a visualization of the print job based on the sensed data.

9. The method of claim 8, wherein the sensed data comprises data collected from a set of one or more sensors comprising at least one selected from the group consisting of a camera, a laser scanner, a motion detector, and an accelerometer.

10. The method of claim 1, wherein:
the second set of data comprises process monitoring data associated with a corresponding part; and
rendering the second visualization comprises rendering a visualization of a print job to print the corresponding part.

11. The method of claim 10, wherein the corresponding part is a historic print job of a prior printing of the part.

12. The method of claim 10, wherein the process monitoring data comprises at least one selected from the group consisting of TCP positions, axis position data, arc voltage data, temperature data, and weld parameters.

13. The method of claim 10, wherein:
rendering the visualization of the print job of the corresponding part comprises generating a picking texture with object IDs associated each pixel of the picking texture; and
the method further comprises:
receiving input identifying a pixel of the picking texture; and
identifying a corresponding object based on the object ID associated with the identified pixel.

14. The method of claim 1, wherein displaying the rendered first and second visualizations comprises displaying a delta between the rendered first visualization and the rendered second visualization.

15. The method of claim 1, wherein the second set of data for the second visualization is based on a rendered visualization based on a third set of data received from the control system.

16. The method of claim 1, wherein the control system operates locally on the set of processors.

17. The method of claim 1, wherein the control system comprises a simulation module, wherein the first set of data comprises simulated data, wherein the control system simulates a first portion, wherein rendering comprises simulating a second portion.

18. A method for updating a print plan, the method comprising:
receiving, at a set of one or more processors, a set of print data, wherein the set of print data comprises robot path data from a control system that controls a set of robots;
rendering, at the set of processors, visualizations based on the print data;
identifying a set of issues based on the rendered visualizations; and
communicating with the control system to update the print plan based on the identified set of issues.

19. The method of claim 18, wherein:
the print data further comprises:
robot configuration data for a set of one or more robots in a print cell; and
path data for the set of robots; and
rendering visualizations based on the print data comprises:
rendering representations of the set of robots based on the robot configuration data; and
rendering movement of the set of robots over time based on the path data.

20. The method of claim 19, wherein:
the print data further comprises:
a first set of print data of a print job being performed in a physical print cell; and
a second set of print data of a target print job; and
rendering visualizations based on the print data comprises:
rendering a first representation of the print job being performed in the physical print cell based on the first set of print data; and
rendering a second representation of the target print job based on the second set of print data, wherein the target print job is computed using a physics engine.
